(19) United States
(12) Patent Application Publication
(10) Pub. No.: US 2026/0181100 A1
(43) Pub. Date: Jun. 25, 2026

(54) METHOD AND SYSTEM FOR GENERATING AN IMAGE AND ITS USE TO ENCODE AND ENCRYPT INFORMATION

(71) Applicant: SGDL INNOVATION SA, Genève (CH)

(72) Inventor: Jean-François ROTGÉ, Montréal (CA)

(73) Assignee: SGDL INNOVATION SA, Genève (CH)

(21) Appl. No.: 19/124,674

(22) PCT Filed: Oct. 20, 2023
(86) PCT No.: PCT/IB2023/060636

§ 371 Date: Apr. 25, 2025

(30) Foreign Application Priority Data
Oct. 27, 2022 (CA) 3180047

(51) Int. Cl. H04N 1/60; H04N 1/62

(52) U.S. Cl. CPC H04N 1/6058; H04N 1/6019; H04N 1/6027; H04N 1/62

(57) ABSTRACT

A method and system are described for encoding and encrypting information. The method comprises obtaining information to encode, generating a partition, the partition being generated using at least one of a Jordan polygon generator, an SFC generator, and a closed Hamiltonian path generator; converting the generated partition into a series of triplets representing the partition, in which each triplet is defined by a point and its two neighbors; determining a density associated with each point using the series of triplets; coloring each point using at least the associated density to generate the unicellular topological stencil. The method is characterized in that the information to encode is used in at least one of the generation of the partition, the determination of the density associated with each point, and the coloring of each point.

### PRIORITY

This patent application claims priority of the patent application entitled “METHOD AND SYSTEM FOR GENERATING AN IMAGE AND ITS USE FOR ENCODING AND ENCRYPTING INFORMATION” filed on Oct. 27, 2022 in Canada and bearing number 3,180,047.

### TECHNOLOGICAL FIELD

The current invention relates to the field of cryptography. More specifically, this patent application relates to a method and a system for generating an image and its use for encoding and encrypting information.

### PRIOR ART

Examples of graphic alphabet that allow to generate images are disclosed in the references Ref. [26, 49, 88] as well as in the reference Ref. [77].

Examples of geometric partition of a painting are disclosed in the references Ref. [8, 73].

Examples of colorization of a region by diffusion filling are disclosed in the references Ref. [11, 72].

Examples of region colorization by topological filling methods are disclosed in reference Ref. [17].

Early examples of graphical identifiers historically created by seals are disclosed in reference Ref. [27].

Early examples of graphical identifiers created by coats of arms are disclosed in references Ref. [1, 69, 90].

Early examples of graphical identifiers created by stamps are disclosed in references Ref. [44, 51, 66, 71].

First examples of graphical identifiers of the Gengi symbol type can be found in references Ref. [3, 38].

An example of a traditional graphical identifier transposed into the digital world is disclosed in reference Ref. [22].

An introduction to graphical identifiers of the QR code type is described in reference Ref. [47].

An introduction to graphical identifiers of the barcode type is disclosed in references Ref. [46, 68].

Examples of introductory texts on SFCs are disclosed in references Ref. [16, 19, 24, 32].

The historical texts presenting SFCs are disclosed in references Ref. [5, 6, 7, 10].

Examples of the use of SFCs in cryptography are disclosed in references Ref. [28, 55, 65].

The texts presenting the generalization of Cantor-type SFCs are disclosed in references Ref. [35, 59].

The texts presenting Gray curves and metacurves (MCG) are disclosed in references Ref. [78, 87, 81, 82, 85, 86, 79, 80, 83, 84].

Examples that help differentiate between the principles of randomness and chaos are disclosed in references Ref. [15, 64, 70].

The notion of Kolmogorov complexity is presented in reference Ref. [21].

The concept of attractors in chaos theory is presented in references Ref. [14, 34].

The principle of the One Time Pad (OTP) cryptographic system and random image generation is presented in references Ref. [23, 76].

An example of a chaotic cryptographic system is presented in reference Ref. [62].

Examples of mathematical formalization of patterns are disclosed in references Ref. [4, 20, 40].

The theory of Truchet tilings is disclosed in reference Ref. [2].

The principle of scrambling in cryptography is disclosed in reference Ref. [56].

Examples of the use of SFCs in image encryption are disclosed in references Ref. [36, 41].

Examples of chaotic processes in image cryptography are disclosed in references Ref. [29, 37, 57, 58, 60, 67, 72, 74].

The use of Hilbert curves for text encryption is disclosed in reference Ref. [50].

The principle of self-avoiding walks (SAW) is presented and popularized in reference to illustrate the transformation of a SAW into a Jordan polygon.

It will be appreciated that the prior art suffers from numerous limitations.

Indeed, the problem of generating an encrypted image used in an encryption system characterized by a symmetric and hybrid protocol for encryption keys, which are also the encrypted procedures for generating the encrypted image, is twofold. If the image is purely random (One Time Pad), then the image is mathematically unbreakable, but it becomes impossible to achieve visual identification and digital authentication without a heavy secure library to compare the images. If the image is pseudo-random, decryption may occur with loss, making image authentication by comparison impossible.

Another limitation of the prior art is the gradation of complexity. In fact, the problem related to the complexity of the produced images is tied to the very nature of the images, which can be the result of either organized order, structured complexity, pseudo-random disorder, or random disorder.

Another limitation of the prior art is the security of the encryption protocol. The problem of encryption protocol security lies in obtaining encrypted images that can be visually identified or identified through software or hardware processes. The resilience to attacks is complicated by the level of visual information directly provided by the image, which can facilitate attack vectors. Furthermore, strict adherence to Kerckhoffs's principle, “the adversary knows the system,” provides the adversary with information to break the encryption immediately and possibly the system in the future, which is a problem.

Another limitation of the prior art concerns the fact that hash-type indexing is generally non-reversible with possibilities of collisions. Furthermore, hash functions are cataloged and known to attackers. The challenge in choosing the right indexing CODEC is first related to the selection of new bijective coupling mathematical functions whose construction process is known only to the person generating the encrypted image (anonymous function). The challenge is also related, if necessary, to the choice of coupling functions whose decoding is discouraging due to its complexity. These latter functions can be combined with the previous ones.

Another limitation of the prior art concerns the use of permutation libraries. In fact, the challenge with using permutation libraries lies in the heterogeneity of functions whose computational performances are very unequal, as well as the vulnerability of these functions to attacks. The most well-known libraries are “Chaotic Map” function libraries and bijective image generation function libraries.

Another limitation of the prior art concerns numerical precision. In fact, the issue of numerical precision is essentially due to the use of floating-point numbers in calculations, which prevent precise tests in topological tests during encoding phases and cause precision losses in decoding functions, leading to the loss of authentication capability due to the non-bijective nature of numerical functions.

Another limitation of the prior art concerns memory management. The skilled addressee will appreciate that the issue of memory management may be due to the memory size of imported static images such as photos or QR codes, the size of dynamically produced images such as color tables, and finally the size of Jordan polygons due to the number of vertices in the polygon.

Another limitation of the prior art is in the programming itself. In fact, the issue of programming arises from the different parallelism paradigms encountered: data parallelism for pixel coloring and task parallelism for topological region coloring.

There is therefore a need for at least one method and system that can address at least one limitation present in the prior art.

### SUMMARY

According to one aspect of the technology, a visual identification and authentication system is disclosed, producing an encrypted image or a video stream of encrypted images.

According to one aspect of the technology, a computer-implemented method is disclosed for encoding information using a unicellular topological stencil, the method comprising obtaining information to encode; generating a partition in a square, the partition being generated using at least one of a generator of Jordan polygons, a generator of “Space Filling Curves” (SFC), and a generator of closed Hamiltonian paths; converting the generated partition into a series of triplets representing the partition, wherein each triplet is defined by a point and its two neighbors; determining a density associated with each point in the square using the series of triplets; coloring each point in the square using at least the associated density to generate the unicellular topological stencil; and providing the unicellular topological stencil; characterized in that the information to encode is used in at least one of the generation of the partition in a square, the determination of the density associated with each point in the square, and the coloring of each point in the square.

According to one or more embodiments, the coloring of each point in the square comprises associating a given color with each determined density.

According to one or more embodiments, the coloring of each point in the square comprises, for a given point, associating a given color table with each density and selecting a color from the given color table using the position of the given point in the square.

According to one or more embodiments, the method further comprises obtaining an SFC or a coding MCG traversing the square, and reordering each point of the unicellular topological stencil using the SFC or the coding MCG to provide a scrambled unicellular topological stencil, the reordering modifying the coordinates of each point of the unicellular topological stencil such that for each given point with initial corresponding coordinates in a given scan, new coordinates are assigned to this point, these new coordinates corresponding to an identical index in the SFC or in the coding MCG as an index in the given scan; characterized in that the information to encode is used in at least one of the generation of the partition in the square, the determination of the density associated with each point in the square, the coloring of each point in the square, and the obtaining of the SFC or the coding MCG.

According to one aspect of the technology, a computer-implemented method is disclosed for encoding information using a tiling generated in a square, the method comprising obtaining information to encode; generating an SFC in a square; generating a tiling in the square using the generated SFC; the tiling being generated by replacing each elementary portion of the SFC with a corresponding tiling; and providing an indication of the generated tiling, the method being characterized in that the information to encode is used during the generation of the SFC.

According to one or more embodiments, the SFC is defined by 8 elementary portions in an “S” shape and the corresponding tiling corresponds to a given identical and fixed tiling for each of the 8 elementary portions.

According to one or more embodiments, the method further comprises obtaining an ASCII string to encode, converting the ASCII string into a sequence of corresponding codes in a given numerical base filling a square table, generating an SFC using a given Gray SFC directrix curve in which each point of the Gray SFC directrix curve is replaced by a pattern corresponding to a given code in the sequence of corresponding codes.

According to one aspect of the technology, a computer-implemented method is disclosed for encoding information using an image, comprising obtaining a first image having a given number of pixels; obtaining a second image having a given number of pixels identical to the given number of pixels of the first image; interleaving the first image with the second image to provide an interleaved image, the interleaved image comprising a given number of metapixels identical to the given number of pixels of the first image, each metapixel comprising: a central portion comprising at least one pixel having an associated value equal to that of a corresponding pixel in one of the first image and the second image, a peripheral portion surrounding the central portion, the peripheral portion comprising a plurality of pixels each having an associated value equal to that of the corresponding pixel in the other of the first image and the second image; and providing the interleaved image, characterized in that the first image is selected from a group of images comprising at least: a unicellular topological stencil generated using the method described above.

According to one or more embodiments, the group of images further comprises a tiling generated using the method described above.

According to one or more embodiments, the group of images further comprises a given image.

According to one or more embodiments, the group of images further comprises a QR code.

According to one or more embodiments, the group of images further comprises at least one of a static color table and a dynamic color table.

According to one or more embodiments, the dynamic color table is generated using a method comprising: generating a two-dimensional SFC traversing the square; and using a hash function to dynamically associate colors from an RGB color cube to each pixel of the square, wherein the association is controlled by the hash function using at least one parameter and the generated SFC.

According to one or more embodiments, the interleaving scheme is selected from a group comprising four typographic modes.

According to one or more embodiments, the method further comprises obtaining an SFC or a coding MCG traversing the interleaved image, and reordering each point of the interleaved image using the SFC or the coding MCG to provide a scrambled unicellular topological stencil, the reordering modifying the coordinates of each point of the interleaved image such that for each given point with initial corresponding coordinates in a given scan, new coordinates are assigned to this point, the new coordinates corresponding to an identical index in the SFC or in the coding MCG as an index in the given scan; the reordering allowing for the provision of a scrambled interleaved image.

According to one or more embodiments, the method disclosed above is used to encrypt information.

According to one or more embodiments, there is disclosed a unicellular topological stencil generated using the method mentioned above.

According to one or more embodiments, there is disclosed an image generated using the method mentioned above.

According to one or more embodiments, there is disclosed a use of the previously mentioned image to identify or authenticate an element.

According to one or more embodiments, the element is an object.

According to one or more embodiments, there is disclosed a computer-implemented method for performing identification or authentication using a dynamic color table in a square, the method comprising: generating a two-dimensional SFC traversing a square comprising a plurality of pixels; using a hash function to dynamically associate colors from an RGB color cube to each pixel of the square, wherein the association is controlled by the hash function using at least one parameter and the generated SFC; and providing the generated color table, the generated color table allowing for identification or authentication.

According to one or more embodiments, the aforementioned method further comprises modifying the value of each pixel in the generated color table.

### BRIEF DESCRIPTION OF THE FIGURES

One or more embodiments of the invention and its advantages will appear in more detail in the following description with examples provided for guidance with reference to the attached figures.

FIG. 1 illustrates an example of a level 7 MCG;

FIG. 2 illustrates a reordering by rotor-based MCG;

FIG. 3 illustrates the taxonomy of Gray curves;

FIG. 4 illustrates the taxonomy of Jordan polygons;

FIG. 5 illustrates self-avoiding paths;

FIG. 6 illustrates the ghost points of a U-shaped metacurve;

FIG. 7 illustrates the ghost points of a W-shaped metacurve;

FIG. 8 illustrates an example of an encrypted table tabCODE (7,[1234, 12345]);

FIG. 9 illustrates an example of a kinetic and chaotic effect;

FIG. 10 illustrates an example of a kinetic table and visual interferences;

FIG. 11 illustrates examples of dynamic tables;

FIG. 12 illustrates colorimetric fingerprints in mode 2;

FIG. 13 illustrates colorimetric fingerprints in mode 1;

FIG. 14 illustrates the coloring of densities;

FIG. 15 illustrates the coloring of letters A and B with 2 and 3 connected components;

FIG. 16 illustrates the coloring of the word AB with 5 connected components;

FIG. 17 illustrates the principle of a metapixel;

FIG. 18 illustrates the typographic modes associated with a metapixel;

FIG. 19 illustrates the control modes 0 and 1 of the metapixels;

FIG. 20 illustrates the interleaving of an encrypted dynamic table and a photo image;

FIG. 21 illustrates the interleaving of a dynamic table and a static image (photo);

FIG. 22 illustrates the interleaving of a dynamic table and a static QR code;

FIG. 23 illustrates the scrambling of the resulting images from FIGS. 20 and 22;

FIG. 24 illustrates a Majus effect from a dynamic table;

FIG. 25 illustrates the association between encryption keys and topological regions;

FIG. 26 illustrates a multiple Jordan topological partitioning;

FIG. 27 illustrates dynamic encrypted tables in kinetic and chaotic mode;

FIG. 28 illustrates a density table associated with a topological stencil;

FIG. 29 illustrates a general association of dynamic tables;

FIG. 30 illustrates examples of initializing hash tables of dynamic tables;

FIG. 31 illustrates a Majus effect by interleaving a digital photo and a dynamic table;

FIG. 32 illustrates a Majus effect with a precomputed dynamic table;

FIG. 33 illustrates the construction of a multicellular tiling;

FIG. 34 illustrates the 8 Peano-Truchet patterns;

FIG. 35 illustrates the generation of a regular Peano-Truchet tiling without symmetries;

FIG. 36 illustrates the generation of a regular Peano-Truchet tiling;

FIG. 37 illustrates the octal representation of a DC2(i,2,[6,2],[11]) meta-curve described in reference Ref. [86];

FIG. 38 illustrates the octal representation of an SW spiral;

FIG. 39 illustrates the measurements and proportions of the calibration target;

FIG. 40 illustrates the calibration of the octal calibration target;

FIG. 41 illustrates a geometric and alphanumeric octal;

FIG. 42 illustrates the encoding of a text in octal on a spiral SFC;

FIG. 43 illustrates the insertion of a binary message by interleaving;

FIG. 44 illustrates the quaternary encryption of the Chimera type;

FIG. 45 illustrates the octal encryption of a text with a SFC directrix curve DC0uM;

FIG. 46 illustrates an ordering of the PPM colors;

FIG. 47 illustrates a method for encoding information using a unicellular topological stencil according to an embodiment;

FIG. 48 illustrates a method for encoding information using an image according to an embodiment;

FIG. 49 illustrates a method for encoding information using a tiling;

FIG. 50 illustrates a topological plane partitioning generator (SLstencyISYS1);

FIG. 51 illustrates a dynamic color table generator (SLstencyISYS2);

FIG. 52 illustrates a geometric tiling generator (SLstencyISYS3);

FIG. 53 illustrates a color palette generator (SLstencyISYS4);

FIG. 54 illustrates a matching system between topological indicators and colors (SLstencyISYS5);

FIG. 55 illustrates a typographic configurator based on metapixels (SLstencyISYS6);

FIG. 56 illustrates a binary table generator from text (SLstencyISYS7);

FIG. 57 illustrates the code of the function tabDC;

FIG. 58 illustrates the code of the function tabCD;

FIG. 59 illustrates the code of the function polJORD;

FIG. 60 illustrates the code of the function indDC;

FIG. 61 illustrates the code of the function indJFR;

FIG. 62a illustrates the code of the function indSOM;

FIG. 62b illustrates the code comments of the function indSOM;

FIG. 63a illustrates the code of the function cctQUA;

FIG. 63b illustrates the code comments of the function cctQUA;

FIG. 64a illustrates the code of the function ptsQUA;

FIG. 64b illustrates the code comments of the function ptsQUA;

FIG. 65a illustrates the code of the function indJFRQ2;

FIG. 65b illustrates the code comments of the function indJFRQ2;

FIG. 66a illustrates the code of the function tabCODE;

FIG. 66b illustrates the code comments of the function tabCODE;

FIG. 67a illustrates the code of the function tabDC3;

FIG. 67b illustrates the code comments of the function tabDC3;

FIG. 68a illustrates the code of the function indRGBv;

FIG. 68b illustrates the code comments of the function indRGBv;

FIG. 69a illustrates the code of the function tabPIX;

FIG. 69b illustrates the code comments of the function tabPIX;

FIG. 70a illustrates the code of the function IstabDYN;

FIG. 70b illustrates the code comments of the function IstabDYN;

FIG. 71a illustrates the code of the function tabDYN;

FIG. 71b illustrates the code comments of the function tabDYN;

FIG. 72a illustrates the code of the function rgbCODE;

FIG. 72b illustrates the code comments of the function rgbCODE;

FIG. 73a illustrates the code of the function codeRGB;

FIG. 73b illustrates the code comments of the function codeRGB;

FIG. 74a illustrates the code of the function colMIRE;

FIG. 74b illustrates the code comments of the function colMIRE;

FIG. 75a illustrates the code of the function Isv2v3DENS;

FIG. 75b illustrates the code comments of the function Isv2v3DENS;

FIG. 76a illustrates the code of the function modPPM;

FIG. 76b illustrates the code comments of the function modPPM;

FIG. 77a illustrates the code of the function TAB2dpi;

FIG. 77b illustrates the code comments of the function TAB2dpi;

FIG. 78a illustrates the code of the function CAS2dpi;

FIG. 78b illustrates the code comments of the function CAS2dpi;

FIG. 79a illustrates the code of the function intMPIX;

FIG. 79b illustrates the code comments of the function intMPIX;

FIG. 80 illustrates the code of the function SCRIPT003;

FIG. 81 illustrates the code of the function SCRIPT004;

FIG. 82 illustrates the code of the function SCRIPT007;

FIG. 83 illustrates the code of the function SCRIPT008;

FIG. 84a illustrates the code of the function celUNI;

FIG. 84b illustrates the code comments of the function celUNI;

FIG. 85 illustrates the code of the function SCRIPTaab;

FIG. 86a illustrates the code of the function casTPZ;

FIG. 86b illustrates the code comments of the function casTPZ;

FIG. 87a illustrates the code of the function rapPTS;

FIG. 87b illustrates the code comments of the function rapPTS;

FIG. 88a illustrates the code of the function ptsBS8;

FIG. 88b illustrates the code comments of the function ptsBS8;

FIG. 89a illustrates the code of the function ptsBS4;

FIG. 89b illustrates the code comments of the function ptsBS4;

FIG. 90a illustrates the code of the function mireOCT;

FIG. 90b illustrates the code comments of the function mireOCT;

FIG. 91a illustrates the code of the function motMIRE;

FIG. 91b illustrates the code comments of the function motMIRE;

FIG. 92a illustrates the code of the function tabMIRE10;

FIG. 92b illustrates the code comments of the function tabMIRE10;

FIG. 93a illustrates the code of the function tabMIRE12;

FIG. 93b illustrates the code comments of the function tabMIRE12;

FIG. 94a illustrates the code of the function texOCT;

FIG. 94b illustrates the code comments of the function texOCT;

FIG. 95a illustrates the code of the function sfcBS84;

FIG. 95b illustrates the code comments of the function sfcBS84;

FIG. 96a illustrates the code of the function posTAB;

FIG. 96b illustrates the code comments of the function posTAB;

FIG. 97 illustrates the code of the function SCRIPT99j;

FIG. 98 illustrates the code of the function CDOuwLIG;

FIG. 99 illustrates the code of the function DCOuwLIG;

FIG. 100a illustrates the code of the function TABg2lis;

FIG. 100b illustrates the code comments of the function TABg2lis;

FIG. 101 illustrates the code of the function TABg2ppm;

FIG. 102a illustrates the code of the function perRGB;

FIG. 102b illustrates the code comments of the function perRGB;

FIG. 103a illustrates the code of the function rgbTRNG; and

FIG. 103b illustrates the code comments of the function rgbTRNG.

### DETAILED DESCRIPTION

It will be appreciated by the skilled addressee that one or more embodiments of the described method and system offer many advantages.

In particular, one advantage of one or more embodiments of the described method and system is that they provide a system for generating images, notably from new families of space-filling curves in the plane called rotor-based Gray metacurves (MGR). It will be appreciated that these configurable curves have combinatorial generation formulas that can serve as the basis for encryption keys for images in one or more embodiments. It will be appreciated that successive steps using the properties of these curves allow for the disruption of geometric ordering and the breaking of the colorimetric coherence of source images.

In fact, there is disclosed a visual cryptographic system based on topological stencils. It will be appreciated that stencils are particular digital images that allow for the encrypted and secure communication of various types of graphical, visual, or textual information. There is disclosed a system for generating stencils, which relies on topological partitions of the plane created from Jordan polygons. The use of new families of space-filling curves in the plane, called Gray metacurves, enables the creation of encryption keys encoding the plane's partition and acting as topological attractors responsible for encrypting color tables and alphanumeric tables.

### General Presentation of the System

### Topological Stencil and Cryptography

The digital topological stencil (DTS) system is a synthetic image generation system whose synthesis process is concealed and encrypted. It will be also appreciated that a DTS image can also be provided in encrypted form. In this case, no specific visual information is transmitted. The properties of the DTSs are disclosed below from a cryptographic perspective.

A DTS is an image that is partially or entirely procedural, resulting from a new method of image encryption with high complexity, positioned between purely random image generation and chaotic or pseudo-random image generation.

DTSs are a new family of two-dimensional graphical identifiers and authenticators integrating various forms of colorized images. A DTS essentially consists of a solid geometric area that creates a partition of the plane, comprising a boundary and hollowed-out sections. Once defined, this topological partition will be colorized.

DTSs can be considered as digital stamps or seals whose graphic design is procedurally generated using secret and encrypted formulas.

While barcodes and their subfamilies, such as QR codes and datamatrix (except for 2D-docs), are primarily used as identifiers, the DTSs integrate identification and authentication processes into a single system.

Unlike barcode families, which are based on a graphical representation of encrypted text, DTSs are encrypted colorized images that include textual representations and can be mixed using a so-called interleaving system.

It will be appreciated that this interleaving system accepts arbitrary bitmap images, particularly of the following types:
(a) Either DTS-type images, procedurally generated and encrypted,
(b) Or procedural images generated by various systems based on fractals, circular cellular automata, or other chaotic or purely random systems,
(c) Or procedural images derived from various generations of QR codes, datamatrix codes, or others,
(d) Or procedurally generated synthetic images,
(e) Or non-procedural images such as encrypted or non-encrypted photographs.

It will be appreciated that the encryption processes of the DTSs rely on mathematical and algorithmic foundations built around the theory of Space Filling Curves (SFC). This approach allows associating, through encoding, a list of integers, the n-dimensional coordinates, to a unique integer which, through decoding, will restore this list. It will therefore be appreciated that this system is a universal encoding-decoding system for alphanumeric information after its conversion into integers. This system also allows indexing and ordering space. This latter property, in particular, enables scrambling two-dimensional images through permutation.

These SFCs and their generalizations, known as Gray metacurves, make it possible to unify the encryption of topology, colors, and text integrated into the DTSs.

### Encryption Process

In the DTS system, several encryption processes are coupled and interleaved to complicate and nullify any attempt to break the encryption. These processes, which are dynamically configurable, have three levels of encryption. The finest level is that of the parameters of the encryption functions themselves. The second level is the encryption of the type of SFC or MCG functions used. The third level is the encryption of the functional encryption network, i.e., the encrypted description of the interleaving and coupling of the different encryption processes. This description takes the form, at the software level, of encryption scripts or the description of finite automata for the implementation of specialized hardware systems.

The functional diagrams of the processes are illustrated by the following figures and listed below.

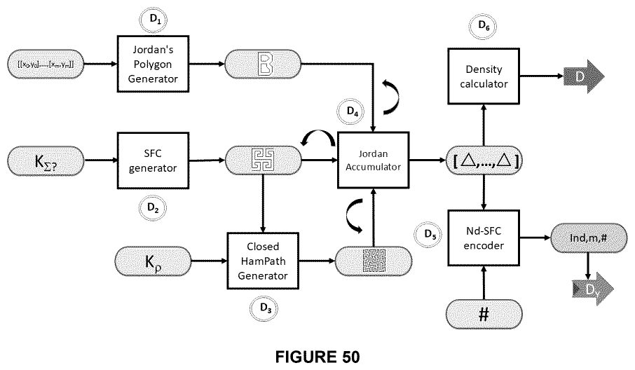

A generator of topological partitioning of the plane is illustrated in FIG. 50.

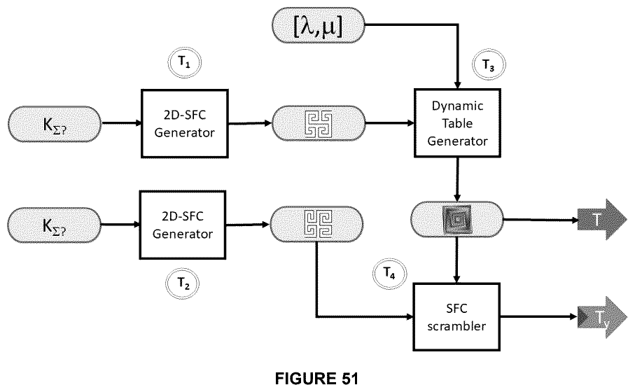

A generator of dynamic color tables is illustrated in FIG. 51.

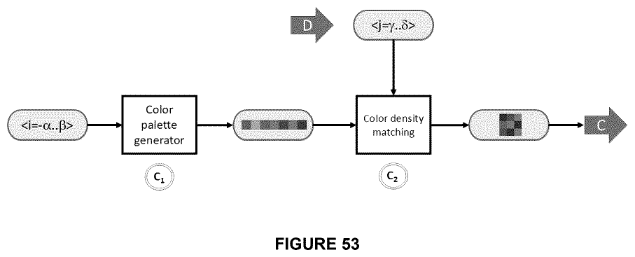

A color palette generator is illustrated in FIG. 53.

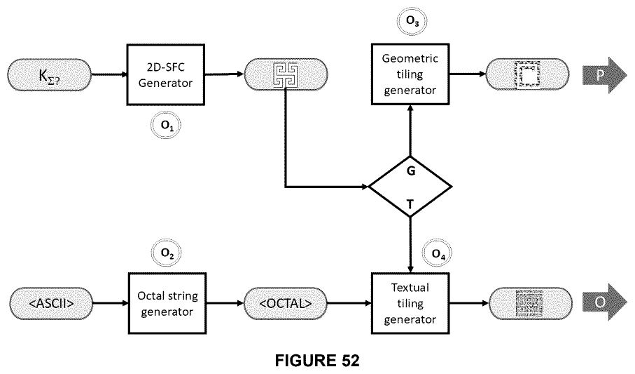

A geometric tiling generator is illustrated in FIG. 52.

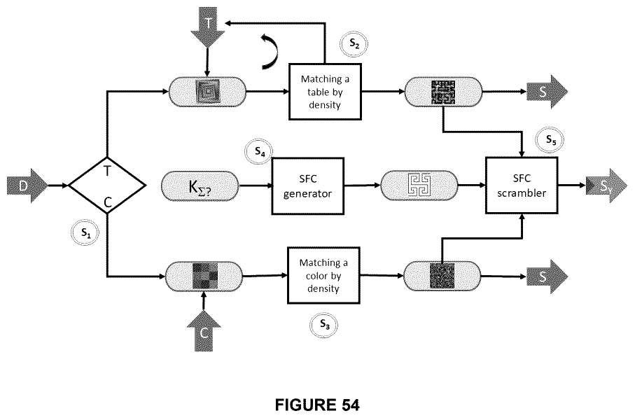

A matching system between topological indicators and colors is illustrated in FIG. 54.

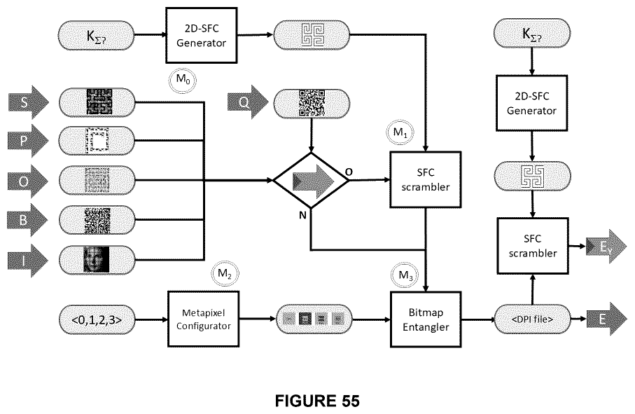

A typographic configurator based on metapixels is illustrated in FIG. 55.

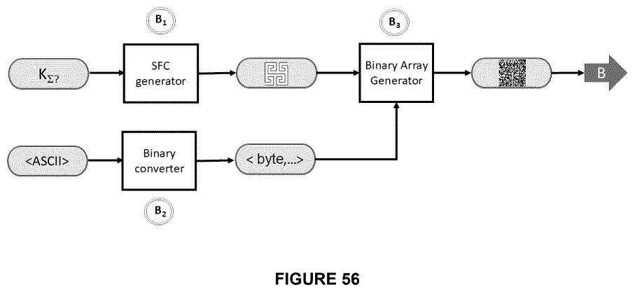

A binary table generator from text is illustrated in FIG. 56.

### Encryption Protocols

It will be appreciated by the skilled addressee that the three levels of encryption described previously are associated with three levels of cryptographic signatures, which are the encryption keys. The encryption protocol thus aims to transmit all the procedural instructions and associated parameters allowing the regeneration of the DTS. On the other hand, the encryption protocol involves the encrypted communication of multi-precision integers (Bignum), this representation being obtained through the encoding and decoding functions of multi-dimensional SFC or MCG, transforming lists of integers into a single integer and vice versa. Typically, the integers representing encryption keys can thus be combinatorially assembled into a new integer that will constitute the final encryption key. This key or its hash will be communicated symmetrically or asymmetrically depending on the deployment context of the protocol: the ability of the recipient of the encrypted message to regenerate the encrypted DTS image or to regenerate the hash of the DTS image.

### Encryption System Security

It will be appreciated by the skilled addressee that the security of one or more system embodiments is of a hybrid type, with an initial assembly of different encryption processes. This approach is somewhat equivalent to the various security components used to prevent counterfeiting of banknotes. However, in the case of DTSs, the number of components is configurable, which introduces a certain degree of security through obscurity and occasional deviation from Kerckhoffs's principle. Regarding the analysis of DTS images, the diffusion and confusion properties mainly depend on the complexity of the functional encryption network and the complexity of the Gray meta-curves used to define the topology of the stencils or their scrambling. Similarly, just as the classic NPCR (Number of Pixels Change Rate) or UACI (Unified Average Changing Intensity) analysis does not apply to certain chaotic images, the use of these indicators must be reassessed in the case of DTSs.

### Algorithmic Principles

It will be appreciated that the principle developed to generate encrypted visual identifiers, known as topological stencils, consists of creating a topological and colorimetric structuring of the plane defined in a purely algorithmic and combinatorial manner. The encryption will therefore be graphical and visual in nature but will have the ability to integrate encrypted textual elements. The parameters of the algorithms will also be used as the first level of encryption keys. From a cryptographic perspective, these parameters feed compositions of bijective mathematical functions that form a second level of encryption keys. These mathematical functions originate from a renewed theory of multidimensional space-filling curves. Understanding the constitutive principles of topological stencils involves the notion of Jordan polygons. Jordan polygons are discrete polygonal structures with the properties of Jordan curves, which are simple closed planar curves forming continuous loops without self-intersection.

### Topological Stencil Principle

It will be appreciated by the skilled addressee that the principle developed to generate graphical identifiers, known as topological stencils, is to create a topological and colorimetric structuring of the plane defined in a purely algorithmic and combinatorial manner. The encryption is therefore graphical and visual in nature but has the ability to integrate encrypted textual elements as described below. The parameters of the algorithms will also be used as the first level of encryption keys. From a cryptographic perspective, these parameters feed compositions of bijective mathematical functions that form a second level of encryption keys.

The mathematical functions originate from the theory of multidimensional space-filling curves (SFC).

The presentation texts on the generalization of Cantor-type SFCs are specifically described in the following references Ref. [35, 59]. The presentation texts on Gray curves and metacurves are described in the following references Ref. [78, 79, 80, 81, 82, 83, 84, 85, 86, 87].

It will be appreciated by the skilled addressee that color tables are indexed sequences of RGB codes without prior ordering of the plane. Therefore, knowing the RGB codes of the table gives no explicit indication of the position of the colors in the plane or their association with coordinate pairs.

It will be appreciated by the skilled addressee that dynamic color tables are color tables computable on the fly, whereas static color tables are precomputed and predetermined tables or images.

### SFC Combinatorial Encryption

In one or more embodiments, the disclosed system stands out from prior art notably through the systematic use of specific families of SFCs and their bijective coupling functions as explained below. It will be appreciated by the skilled addressee that SFCs are combinatorial tools naturally enabling the ordering of n-dimensional spaces and performing point permutations by substituting one SFC ordering with another. One reason why classical SFCs, such as Hilbert curves, appear relatively rarely in image encryption systems is that the number of known SFCs is limited, and generally, the associated encoding and decoding algorithms, due to their simplicity, offer little resistance to attacks.

### MCG Signature and Encryption Key

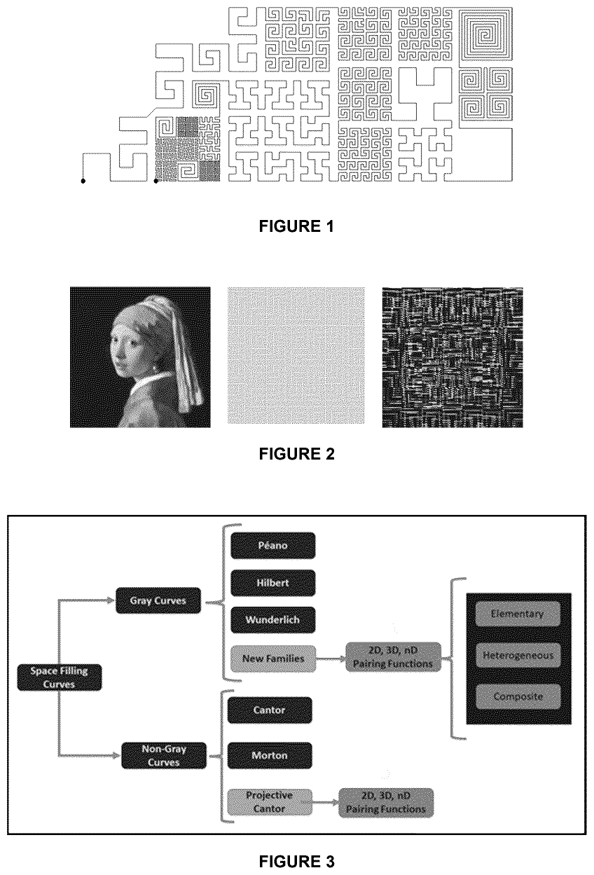

It will be appreciated by the skilled addressee that the signature of an MCG is therefore a sequence of nested lists specifying the parameters of the Gray metacurves assembled to obtain a final metacurve. FIG. 1 illustrates an example of a level-7 composite metacurve, specifically a chain consisting of 12 tiles of different sizes occupied by various heterogeneous and hybrid U- and W-shaped metacurves, referred to as class U and W. The two bold points represent the entry and exit of the Hamiltonian path formed by the composite metacurve. These chains allow encoding and decoding of adaptive Hamiltonian paths on orthonormal grids. In the general case, the signature of a level-7 composite metacurve is as follows (Eq.1):

$$lsDC 7 = \{ \{ [ {x}_{0} , {y}_{0} ] , {a}_{0} , {cs}_{0} , {nv}_{0} , {lsDC}_{0}^{0 … 6} , {sc}_{0} \} … \{ [ {x}_{α} , {y}_{α} ] , \\ {a}_{α} , {cs}_{α} , {nv}_{α} , {lsDC}_{α}^{0 … 6} , {sc}_{α} \} \} \qquad ( 1 )$$

The main metacurve connects a set of α+1 secondary metacurves with levels nv≤6. Each metacurve with index α is contained within a square of dimension aα and centered at coordinates [xα, yα]. The parameter csᵢ specifies the symmetry cases associated with the square of index i. The signature of each metacurve in the set is in the form IsDCα^{0 . . . 6}. A scaling factor sc_{α} is associated with each metacurve, allowing the resulting Hamiltonian path to be indexed on grids of different norms. The syntax of the secondary metacurve signatures takes the form of lists of parameter lists. The syntax of a second-level metacurve (Eq.2) is formulated as follows:

$$lsDC 2 = \{ m , lsRs , lsTP , lsSY \} \qquad ( 2 )$$

$$avec lsRS = \{ {r}_{0} , … , {r}_{m - 1} \}$$

$$et lsTP = \{ {t}_{0} , [ {α}_{0} , {β}_{0} ] , … , {t}_{m - 1} , [ {α}_{m - 1} . {β}_{m - 1} ] \}$$

$$et lsSY = \{ \{ {s}_{0} , … , {s}_{0}^{0 … x} \} , … , \{ {s}_{m - 1} , … , {s}_{m - 1}^{0 … y} \} \}$$

Second-level chaining allows the definition of heterogeneous metacurves formed from first-level metacurves that can be transformed by central symmetry. Symmetry control is possible for all rotor curves regardless of their order in the diophantine signature of the metacurve.

It will be appreciated by the skilled addressee that reordering between metacurves of any level poses no issues, as MCG base changes apply in the same way as for level-0 SFC curves. FIG. 2 illustrates an example of reordering Vermeer's painting, Girl with a Pearl Earring, in a linear SFC base using an inverse meander-type level-1 rotor MCG.

### Surface-Based SFC and MCG Libraries

It will be appreciated by the skilled addressee that the generation of encryption keys through the composition of bijective encoding-decoding functions and, where applicable, the reordering of images can be achieved using purely algorithmic composite and heterogeneous MCGs traversing square Euclidean grids continuously or rectangular Euclidean grids discontinuously. The SFC and MCG coupling functions associated with combinatorial algorithms based on bijective functions for encoding and decoding an integer index into a pair of two-dimensional Euclidean coordinates are grouped into specialized libraries and called via hash tables pointing to the functions. A taxonomy of Gray and non-Gray curves is illustrated in FIG. 3. These non-Gray functions are useful in encrypting sequences of integers into a single integer in any dimensions. It will be appreciated by the skilled addressee that such sequences can be found in the creation and indexing of color tables.

### Hash Tables of SFC or MCG

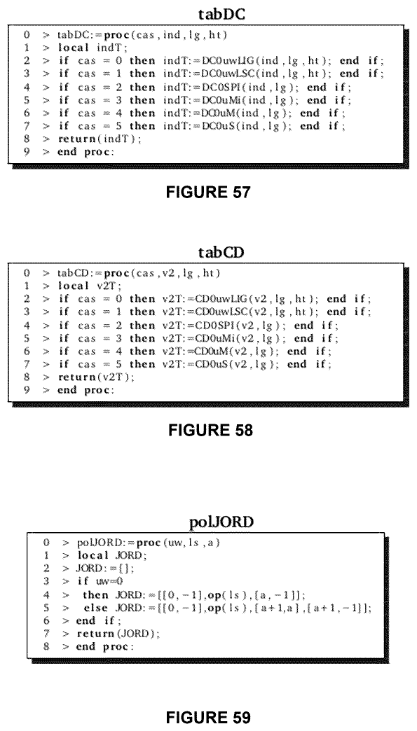

It is possible to establish hash tables of encoding and decoding functions from the set or a subset of these functions. Knowledge of the tables and the functions they contain is necessary to decode the cryptographic signatures of topological stencils. The tabDC functions in FIG. 57 and tabCD in FIG. 58 illustrate, for example purposes, the case-by-case invocation of 5 elementary SFC coupling functions. The SFCs are identified by their indices in the tables. In the case of tables including MCG curves, the signature of each MCG can be transmitted in a form given by the formula Eq.1.

### Method for Generating a Unicellular Topological Stencil

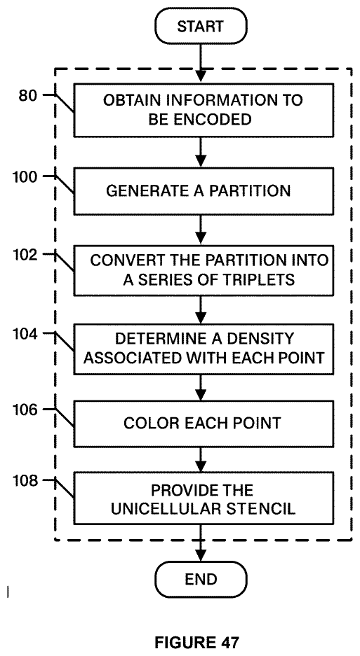

FIG. 47 illustrates a method for encoding information using a unicellular topological stencil according to one or more embodiments.

It will also be appreciated that the unicellular topological stencil is square-shaped in one or more embodiments. More generally, it will be appreciated that the unicellular topological stencil is a particular type of image.

It will also be appreciated by the skilled addressee that the unicellular topological stencil consists of a surface containing a plurality of graphic elements. In one or more embodiments, the graphic element is a pixel or point.

It will be further appreciated that the unicellular topological stencil is generated using a method implemented by a processing device, also called a computer. In fact, it will be appreciated by the skilled addressee that the processing device can be of various types. In particular, the processing device can be selected from a group consisting of desktop computers, servers, smartphones, tablet computers, etc.

According to step 80 of FIG. 47, information to be encoded is obtained. It will be appreciated by the skilled addressee that the information can be of various types and can be used for various purposes. For example, the information to be encoded can be used to identify or authenticate an element. In one or more embodiments, the element is an object.

Furthermore, it will also be appreciated by the skilled addressee that the information to be encoded can be obtained in various ways.

According to one or more other embodiments, the information to be encoded is obtained from the processing device, for example from its memory.

According to one or more other embodiments, the information to be encoded is received from another processing device via, for example, a data network. The skilled addressee will appreciate that the data network can be of various types.

For example, and in one or more embodiments, the data network is a local area network (LAN). In one or more other embodiments, the data network is the Internet.

The skilled addressee will appreciate that the information to be encoded can be obtained in various alternative ways.

According to step 100 of FIG. 47, a partition is generated in a square. It will be appreciated by the skilled addressee that the partition is generated using at least one Jordan polygon generator, an SFC generator, and a closed Hamiltonian path generator.

The skilled addressee will appreciate that Jordan polygons are discrete polygonal structures with the properties of Jordan curves, which are simple closed planar curves forming continuous loops without self-intersection.

### Topological Partition System: General Principles

It will be appreciated by the skilled addressee that the theory of Arithmetic of Forms allows, through a mechanism of arithmetization of topology, the generation of plane partitions with regions created and separated by Jordan polygons. These regions are associated with integers called densities, calculated combinatorially. The partitioning process enables the generation of the partition geometry and, on the other hand, allows the coloring of the topological regions generated by the partitioning.

It will also be appreciated that the coloring by filling SFC curves is thus approached from the perspective of filling discretized curves or Jordan polygons, with the edges, interior, and exterior regions being assigned a thickness.

### Jordan Polygons

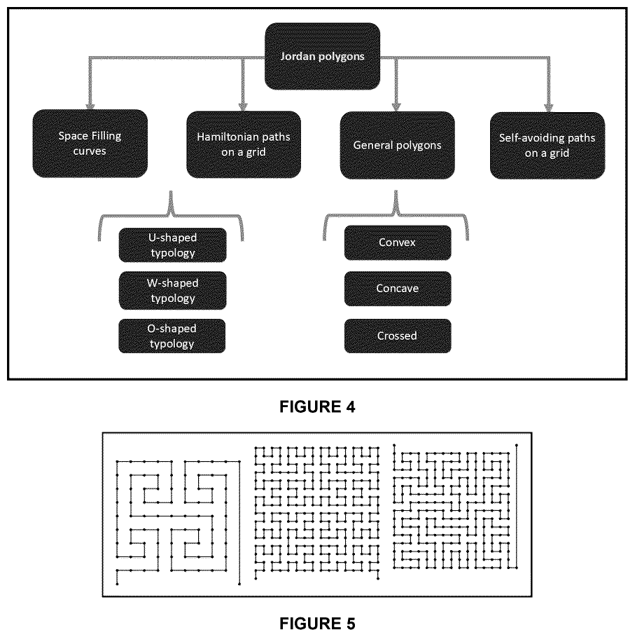

It will be appreciated that, in addition to native Jordan polygons, Gray SFCs, MCGs, as well as certain Hamiltonian or self-avoiding paths and circuits can be transformed into Jordan polygons by closing the respective paths. A taxonomy of Jordan polygons is illustrated in FIG. 4. FIG. 5 illustrates the closure process for an S-shaped SFC (entry and exit points of the SFC diagonally opposite), a U-shaped SFC (entry and exit points of the SFC opposite on one side), and a self-avoiding path.

The polJORD function in FIG. 59 performs the closure of W or U class SFCs or MCGs. The function takes as input the <uw> indicator of the SFC class, <ls> the list of SFC coordinates, and <a> its resolution. The function returns the list <JORD> of the coordinates of the resulting Jordan polygon.

### Arithmetic of Forms

Unlike diffusion-based filling algorithms that apply to connected pixel regions, the described algorithmic principle relies on the topological knowledge of the SFC curve separating the plane into three regions: interior, edge, and exterior. To achieve this, adding two phantom points to the metacurve closes the curve and topologically transforms it into a Jordan curve. After magnifying the metacurve by a minimum factor of 2, which ensures a one-pixel width for the edge as well as for the interior and exterior regions, a theorem for calculating the Poincaré index of a point relative to a Jordan curve is applied. In this case, a theorem derived from the Arithmetic of Forms theory is applied, which calculates the density Ψ of a point relative to a polygon with maximum quadratic representation. This representation involves considering the positional balance of a point relative to each vertex of the polygon associated with a degenerate conic into two lines passing through the edges related to that vertex. It will be appreciated that one of the advantages of the theorem used is its applicability to degenerate polygons or polygons with sequences of collinear vertices, a configuration consistently found with polygonal SFCs.

According to step 102 of FIG. 47, the generated partition is converted into a series of triplets representing the partition. It will be appreciated that each triplet is defined by a point and its two neighbors.

### Density Theorem

The formula Eq.3 accounts for the enumeration of points belonging to the edges of a convex conic <bx>, a concave conic <bv>, outside a convex conic <ex>, and inside a concave conic <iv>.

$$ψ = Ψ - \frac{1}{2} ( bx - bv + 2. ex - 2. iv ) \qquad ( 3 )$$

In the case of a polygon topologically equivalent to a simple Jordan curve, we have a value Ψ=2, and depending on the point's belonging to the different regions delimited by the polygon, we have the following values case by case (Eq.4).

$$ψ = \{ \begin{matrix}0 , & If point is inside \\ 1 / 2 , & If point belongs to a convex vertex \\ 1 , & If point belongs to an edge \\ 3 / 2 , & If point belongs to a concave vertex \\ 2 , & If point is outside\end{matrix}$$

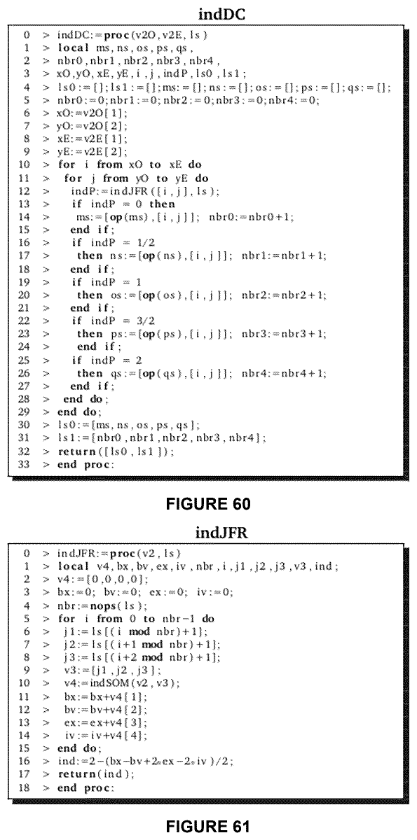

The indDC function in FIG. 60 generates the set of densities of points contained within a given rectangular window, relative to a given polygon. The function takes as input the two endpoints of the diagonal specifying the rectangle, namely the bottom-left origin point <v2O> and the top-right endpoint <v2E>, as well as the list <ls> of the polygon's points. It returns a list of two lists. The first contains the coordinate pairs of points with different densities, and the second contains the numbers of points with different densities.

The indJFR function in FIG. 61 calculates the density of a point relative to a polygon. The function takes as input the coordinate pair <v2> of a point and the list of vertices <ls> of a polygon. It returns the density <ind> of the point relative to the polygon.

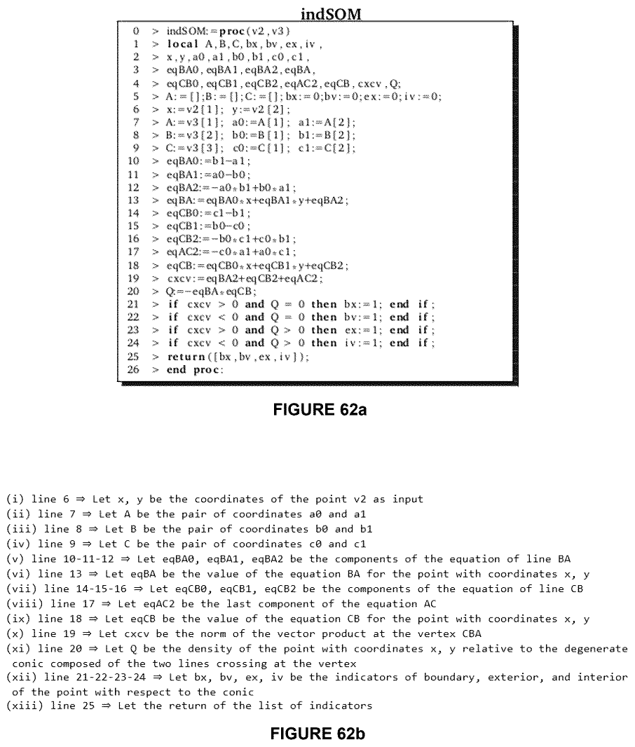

The indSOM function in FIG. 62a, explained in FIG. 62b, performs the calculation of the 4 density cases <bx, bv, ex, iv> for a given vertex. The function takes as input the coordinate pair <v2> of a point and the list of 3 points associated with a given vertex. It returns the list of density indicators for the vertex in question.

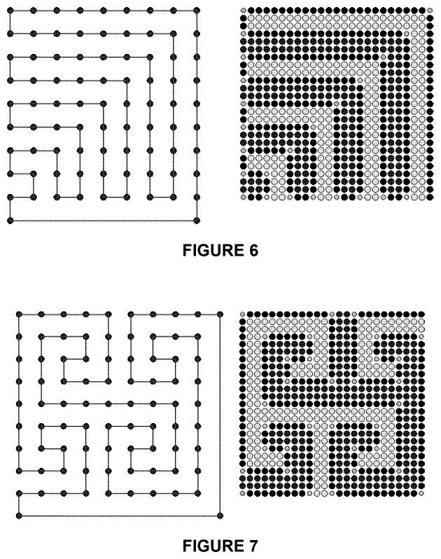

FIGS. 6 and 7 illustrate the coloring of two Gray curves by calculating densities. FIG. 6 shows the coloring of a U-shaped curve with its ghost points represented, and FIG. 7 shows the coloring of a W-shaped curve with its ghost points represented.

### Quadratic Representation

The theorem on the density of a point with respect to a Jordan polygon is based on a combinatorial arithmetic analysis operating vertex by vertex. The vertices described by a sequence of three consecutive points represent conics degenerated into two concurrent lines. Practically, a Jordan polygon is described for algorithmic parallelization purposes of combinatorial calculations as the sequence of its vertices, and the decomposition into degenerated conics is done modularly as the ordered list of vertices is read. Abandoning the sequential representation for a quadratic representation, that is, a representation in a series of triplets of consecutive vertices, which is more costly in terms of space, allows calculations to be performed in parallel on lists of quadratic vertices without prior ordering but, above all, enables topological merging of as many polygons as desired into the same list of vertex triplets. In this case, the permutation of the triplets—their disordering—does not affect the arithmetic analysis of the point with respect to the series of merged polygons.

### Analysis of Densities and Polygon Orientation

$$cctQUA ( [ [ xA , xB , xD , xE ] , [ xF , xG , xH ] , [ xI , xJ , xK , xL , xM , xN ] ] , \\ [ 0 , 0 , 0 ] ) \to [ [ xA , xB , xD ] , [ xB , xD , xE ] , [ xD , xE , xA ] , \\ [ xE , xA , xB ] , [ xF , xG , xH ] , [ xG , xH , xF ] , [ xH , xF , xG ] , [ xI , xJ , xK ] , \\ [ xJ , xK , xL ] , [ xK , xL , xM ] , [ xL , xM , xN ] , [ xM , xN , xI ] , [ xN , xI , xJ ] ] \qquad ( 5 )$$

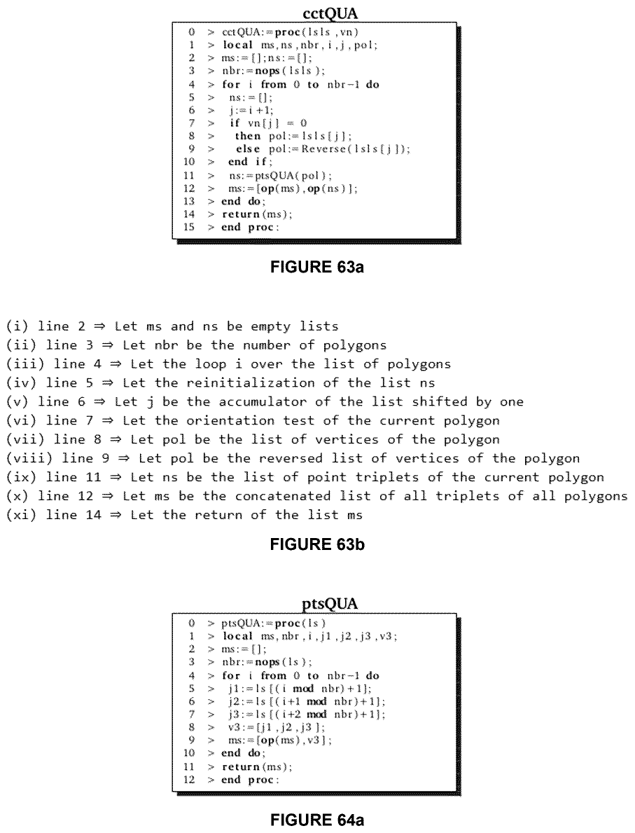

The cctQUA function in FIG. 63a, explained in FIG. 63b, receives a list of polygons, specifically the list <lsls> of vertex lists and <vn> the list of indicators with values {0,1} representing the orientation of the polygons. The function returns the merged list of all triplets for all polygons. The decomposition into triplets is performed considering the orientation of the polygons in the plane. A symbolic example is provided by the sequence Eq.5 (xA represents point A, xB represents point B, etc.).

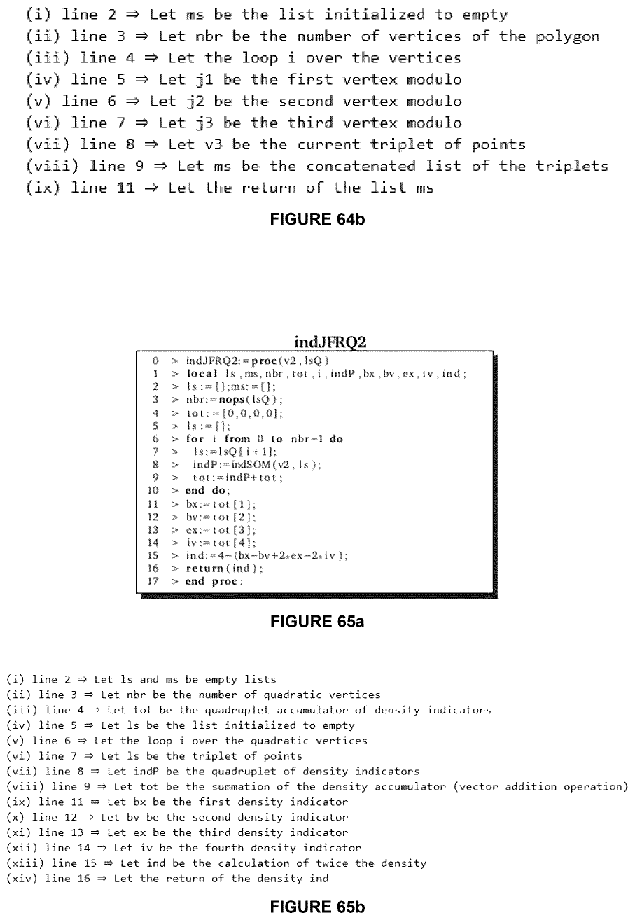

The function ptsQUA in FIG. 64a, explained in FIG. 64b, transforms a sequence of consecutive vertices of a polygon into a list of triplets of points, each triplet consisting of a vertex and its two successors. The function receives the list of consecutive vertices <ptsQUA> and returns the list <ms> composed of the triplets of points. The following example Eq.6 demonstrates the procedure for splitting a list of 5 consecutive vertices.

$$ptsQUA ( [ A , B , C , D , E ] ) \to [ [ A , B , C ] , [ B , C , D ] , \\ [ C , D , E ] , [ D , E , A ] , [ E , A , B ] \qquad ( 6 )$$

According to step 104 of FIG. 47, a density associated with each point of the square is determined using the series of triplets. It will be appreciated that the determined density is used to determine the color associated with each point of the square.

The function indJFRQ2 in FIG. 65a, commented on in FIG. 65b, adapts the calculation of densities to a quadratic representation of the vertices of polygons. It expects <v2> the coordinates of the point whose density is being sought and the list <lsQ> of the quadratic vertices of the polygons. It returns the density of the point being sought. The expression for the density in formula Eq.3 is multiplied by 2 to eliminate the use of rational numbers.

According to step 106 of FIG. 47, each point of the square is colored using at least the associated density to generate the unicellular topological stencil. It will be appreciated by the skilled addressee that the coloring can be performed according to various embodiments.

In one or more embodiments, the step of coloring each point of the square comprises associating a given color with each density.

In one or more embodiments, the step of coloring each point of the square comprises, for a given point, associating each density with a given color table and selecting a color from the given color table using the position of the given point in the square.

### Color Encryption System

It will be appreciated by the skilled addressee that the encrypted communication of colorimetric information is a constant issue in the context of digitized images. It is particularly necessary to distinguish between the case of non-procedural images, such as photographs, and procedural images, which can be regenerated from a limited set of parameters, such as certain fractal images or the dynamic color tables presented in this section. The types of colorimetric information can be classified as follows:
1. The lists of colorized points formed by the coordinates of the points without explicit ordering in the plane and the associated RGB codes.
2. The lists of RGB codes without the coordinates of the points, their ordering in the plane being specified by an associated type of SFC.
3. The lists of parameters allowing the procedural regeneration of the list of colorized points.
4. The lists of parameters allowing the procedural regeneration of a palette or sequence of colors.

The fundamental operations on these types of information are as follows:
1. Data compression,
2. Data encryption,
3. Algorithmic regeneration of data.

### Algorithmic Color Tables

It will be appreciated that in one or more embodiments, the predefined color tables are encrypted using multidimensional SFC curves available in the specialized libraries already described. The example of using a multidimensional indexing algorithm in a DCOuwL-type zigzag pattern (see reference Ref. [86]) illustrates this approach. The idea is to replace the generation of random color tables with the generation of dynamically encrypted color tables. SFC curves act as combinatorial attractors in the same way that certain differential equations serve as strange attractors in chaos theory.

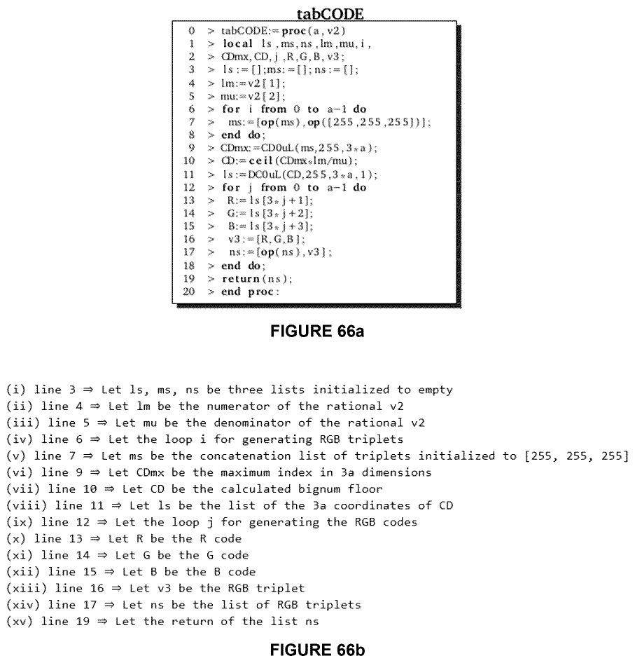

The tabCODE function in FIG. 66a, explained in FIG. 66b, takes as input <a> the resolution of the encrypted color table and <v2> a rational number less than or equal to one in the form [numerator, denominator]. The function returns a list of <a+1> RGB codes.

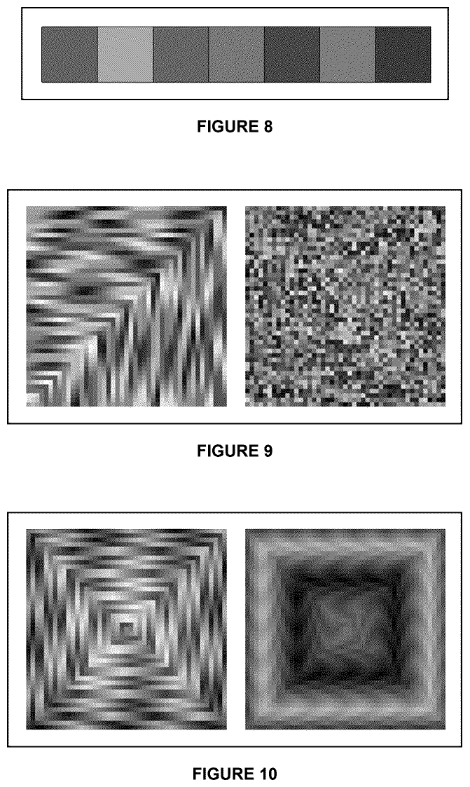

The example given in FIG. 8 illustrates the generation of a color table with seven entries. Using any rational number, for example [1234, 12345], allows obtaining a color table resembling a quasi-random color table. The large integer code of a predetermined <n> RGB color table is simply as follows (Eq.7).

$$CD 0 uL ( [ {α}_{0} , … , {α}_{n - 1} ] , 255 , n ) \qquad ( 7 )$$

### SFC Indexing of RGB Cubes

The 3-dimensional SFCs that enable bijective indexing of different coordinate triplets through coupling offer a means of indexing RGB codes. SFC curves are also used to generate images where each pixel has a different RGB code. Based on a certain number of equivalent principles, it is possible to produce color tables generated on-the-fly algorithmically. However, these tables will exhibit a progressively non-chaotic (monotonic) variation between adjacent RGB codes.

To introduce a certain level of chaos into color tables, a SFC-based algorithm that generates an RGB code associated with a given index is disclosed. Unlike conventional approaches, the algorithm uses a three-dimensional SFC table that allows dynamically changing the SFC indexing base and, on the other hand, introduces a control parameter for the chaotic distribution of colors.

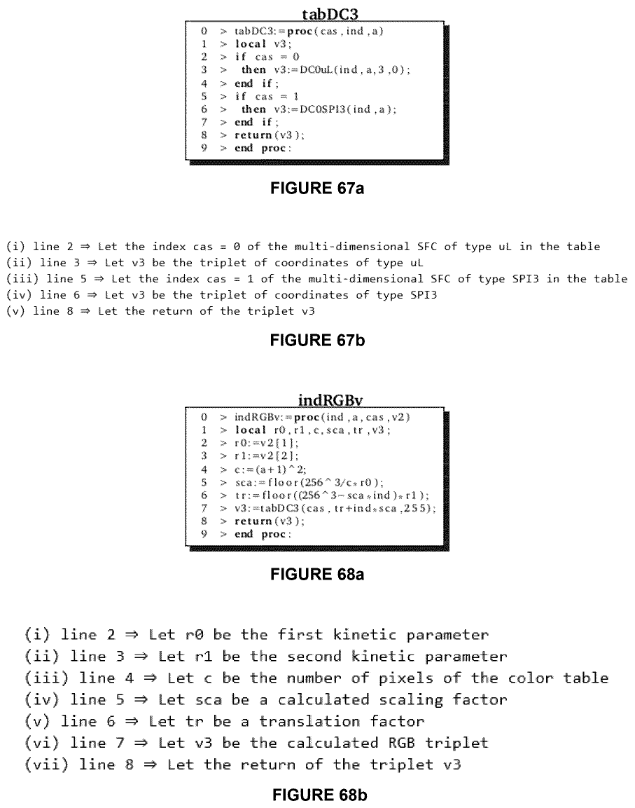

The tabDC3 function in FIG. 67a, commented on in FIG. 67b, corresponds to the call code for a three-dimensional SFC table that returns a triplet of coordinates based on a given index. This table, limited for example purposes, can be extended with any new 3D SFCs, such as variants of Hilbert curves or other Gray SFCs. The function takes as input the <cas> type of SFC, the <ind> index of the point on the curve, i.e., the RGB index, and <a>, the resolution of the curve. The function returns <v3>, the triplet corresponding to the desired RGB code.

Finally, the ordering of the color tables can be modified by changing the SFC reading base in two dimensions of the color table, and the RGB codes can be altered by specifying the RGB code permutation indicator, which allows choosing among the 6 combinations: RGB, RBG, GBR, GRB, BRG, BGR.

### SFC Attractors: Chaos and Kinetic Effects

The developed algorithms combine the Cartesian position of the points of a SFC directrix curve with RGB codes, which are calculated by matching RGB codes belonging to RGB cubes in the SFC plane. The matching parameters from three-dimensional space to two-dimensional space allow the color palette to be dynamically modified. These modifications create kinetic visual interference effects or chaotic color distribution effects.

The SFC directrix curves act as true attractors. FIG. 9 shows an example of kinetic effects resulting from the variation of a pair of coefficients used to generate tables with a spiral-type SFC directrix curve. These kinetic effects allow the definition of color tables visually close to the guide (on the left of the figure) or with visual interference effects (on the right of the figure).

Moreover, the different combinations between the types of SFC directrix curves and the chosen SFC indexing type of the RGB cube also allow transitioning from a kinetic visual mode to a chaotic visual mode. FIG. 10 shows an example of a kinetic effect on the left side of the image (SFC of type DC0uM) transformed into a chaotic effect by simply substituting the chosen RGB cube model.

The principle of mapping the space of an RGB cube to a color palette in the plane equipped with a SFC directrix curve can be formulated in a series of algorithmic variants. These algorithmic variants can be interchanged using hash tables. The principles of coloring two-dimensional palettes are presented based on the following algorithmic variant.

The indRGBv function from FIG. 68a, commented on in FIG. 68b, generates an RGB code from a given index, a chosen type of SFC, and a number that allows chaotic modification of the color table. The function receives <ind>, the index in question, <a>, the resolution of the color table by square convention, <cas>, which specifies the type of 3D SFC performing bijective indexing, and <v2>, the kinetic pair, i.e., the pair of positive real numbers less than or equal to one that controls the chaotic nature of the table. The function returns the triplet <v3> corresponding to the calculated RGB code.

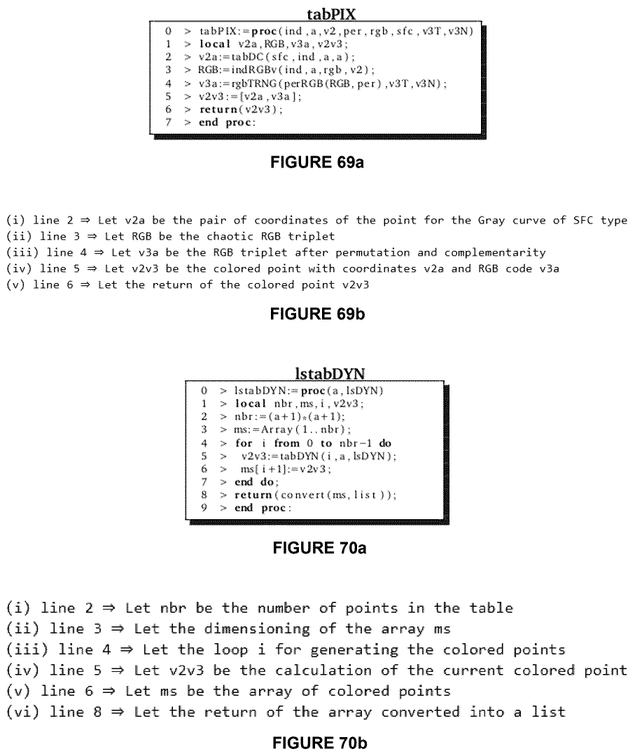

The tabPIX function in FIG. 69a, explained in FIG. 69b, takes as input <ind> the index of the point to be colored, <a> the resolution of the table, <v2> the pair of kinetic values of the table, <per> the color permutation code ranging from 0 to 5, <rgb> the type of RGB code indexing cube, <sfc> the type of SFC curve, <v37> the translation vector of RGB codes, and <v3N> the complementarity vector of colors (negatives). The function returns the pair representing the colored pair formed by its coordinates and its color code.

### Dynamic Tables

It will be appreciated that dynamic tables are intended to replace randomly or quasi-randomly generated tables. They allow the color of a point to be calculated on the fly without prior precalculation or storage of the table, and they are procedurally generated by a set of parameters forming the table's signature (Eq.8). This signature will be used as a cryptographic key.

### Cryptographic Signature

$${K}_{a} = \{ ℳ , 𝒱 , 𝒫 , ℛ , 𝒮 , 𝒯 , 𝒩 \} \qquad ( 8 )$$

$$avec ℳ = \{ 0 , 1 , 2 \}$$

$$et 𝒱 = [ α , β ]$$

$$et 𝒫 = \{ 0 , … , 5 \}$$

$$et ℛ = \{ 0 , 1 , 2 , … \}$$

$$et 𝒮 = \{ 0 , 1 , 2 , … \}$$

$$et 𝒯 = {[ {t}_{0} , {t}_{1} , {t}_{2} ]}_{rgb}$$

$$et 𝒩 = {[ \{ 0 , 1 \} , \{ 0 , 1 \} , \{ 0 , 1 \} ]}_{rgb}$$

### Examples

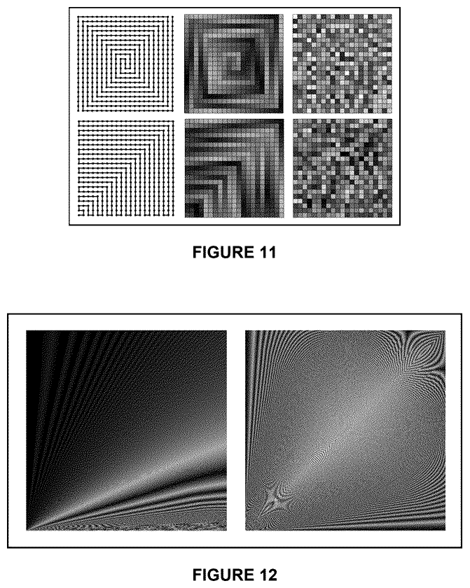

FIG. 11 illustrates the visual result of four color tables defined by the formulations Eq.9 and Eq.10. The two upper tables' two-dimensional directive SFC is of the DC0uS spiral type, and the 3D indexing SFCs are respectively of type 0 and 1, with the RGB code permutation indicators being 5 and 0, respectively. The choice of the kinetic factor pair allows generating a table with a kinetic effect and then a table with a chaotic effect. The sequences of calls to the following functions illustrate the injection of the generator parameters of the terminal RGB codes.

$$perRGB ( indRGBv ( i , 20 , 0 , [ \text{.12} , \text{.1} ] ) , 5 ) \qquad ( 9 )$$

$$perRGB ( indRGBv ( i , 20 , 1 , [ \text{.512} , \text{.93123} ] ) , 0 )$$

The two-dimensional SFC directing the two lower tables is of the DC0uM meander type, while the 3D indexing SFCs are respectively of type 0 and 1. The choice of the pair of kinetic factors also allows generating a table with a kinetic effect and then a table with a chaotic effect. As before, the call sequences of the following functions illustrate the injection of the generator parameters of the terminal RGB codes.

$$perRGB ( indRGBv ( i , 20 , 0 , [ \text{.12} , \text{.1} ] ) , 5 ) \qquad ( 10 )$$

$$perRGB ( indRGBv ( i , 20 , 1 , [ \text{.12512} , \text{.13123} ] ) , 0 )$$

The IstabDYN function from FIG. 70a, explained in FIG. 70b, takes as input the resolution <a> of the table and the list <lsDYN> of parameters forming its cryptographic signature. The function returns a list of colored points, which is a list of pairs consisting of a coordinate pair and a RGB code.

### Visual Complexity of Dynamic Tables

The pair of coefficients that control the chaotic or kinetic appearance of dynamic color tables is applied in the previous examples to all the pixels of the generated tables. The possibility of modifying this pair based on the pixel's position in the plane is introduced. This position depends on the SFC directrix curve of the table. The general principle is as follows:
1. In mode 0, the color calculation depends on certain parameters, including the point index and the pair of kinetic coefficients. This pair has constant values for every pixel in the plane traversed by the SFC directrix curve. Continuous variations of these values allow for interactive and real-time dynamic variations of the color palette.
2. In mode 1 and mode 2, the pair of kinetic coefficients is calculated for each point of the plane and the directrix curve. To do this, the pair of coefficients is recalculated based on the coordinates of each point. The pair of coefficients provided as a parameter of the algorithm is interpreted as a pair of weighting coefficients applied to each coordinate of the point after successive point transformations.
3. The principle can be extended to any point transformation allowing the calculation of kinetic coefficients from point transformations of the coordinates.

Two examples of modifying kinetic coefficients through successive point transformations are formulated by equations Eq.11 and Eq.12.

$$[ \frac{α ( x + 1 )}{α ( x + 1 ) + β ( y + 1 )} , \frac{β ( y + 1 )}{α ( x + 1 ) + β ( y + 1 )} ] \qquad ( 11 )$$

$$[ 2 \frac{α ( x + 1 ) β ( y + 1 )}{{{α}^{2} ( x + 1 )}^{2} + {{β}^{2} ( y + 1 )}^{2}} , \frac{\vert {{α}^{2} ( x + 1 )}^{2} - {{β}^{2} ( y + 1 )}^{2}}{{{α}^{2} ( x + 1 )}^{2} + {{β}^{2} ( y + 1 )}^{2}} ] \qquad ( 12 )$$

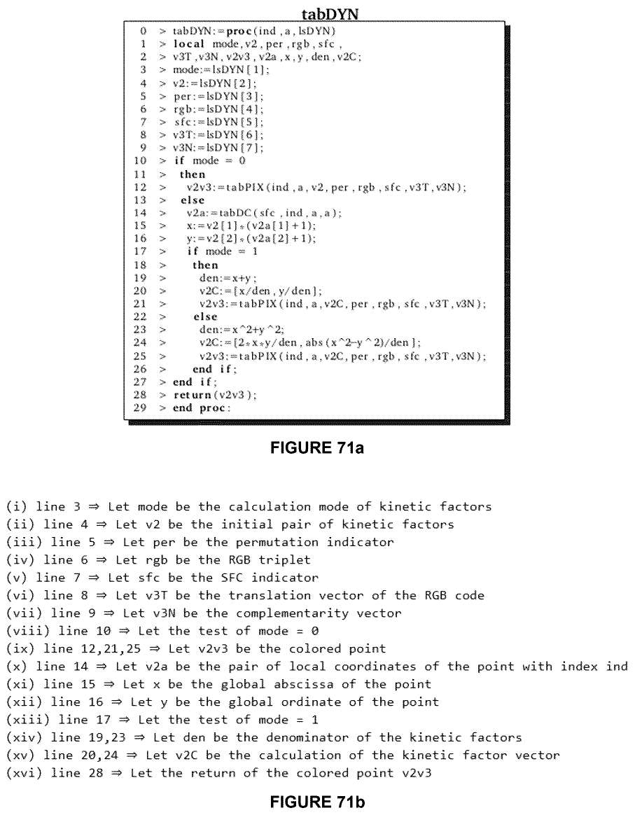

The tabDYN function in FIG. 71a, explained in FIG. 71b, takes as input <ind> the index of the point to be colored, <a> the resolution of the generated table, and <lsDYN> the list of parameters of its cryptographic signature. The function returns the pair <v2v3> representing the colored point, consisting of its coordinates and its color code. The function operates in three modes described earlier.

According to one aspect of the invention, there is disclosed a computer-implemented method for performing identification or authentication using a dynamic color table within a square, the method comprising: generating a two-dimensional SFC traversing a square containing a plurality of pixels; using a hash function to dynamically associate colors from an RGB color cube to each pixel of the square, wherein the association is controlled by the hash function using at least one parameter and the generated SFC; and providing the generated color table, the generated color table enabling identification or authentication.

According to one or more embodiments, the method further comprises modifying the value of each pixel in the generated color table.

### Examples

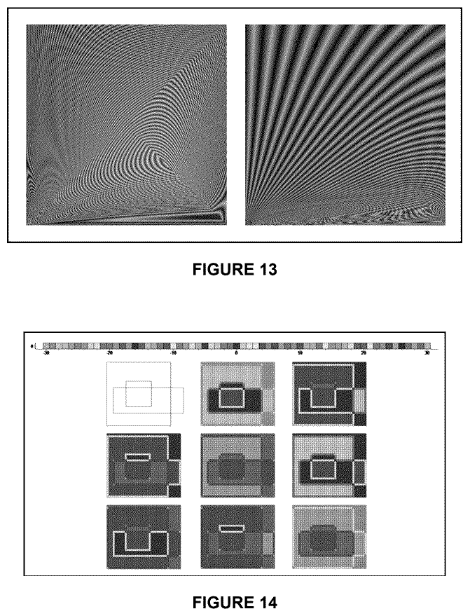

The increase in visual complexity of dynamic color tables is illustrated by FIGS. 12 and 13. The formation of fingerprint-shaped color tables visually combines with geometric moiré effects. FIG. 12 illustrates the result of calculations performed using Equation Eq.11, while FIG. 13 illustrates the result of calculations performed using Equation Eq.12.

### Encoding a Color Palette

It will be appreciated that encoding a color palette, that is, a sequential list of unordered RGB codes, aims to communicate this list securely and confidentially. The developed encryption principle involves operating in a space of dimension <3n> where <n> is the number of colors in the list. The list of RGB codes given as triplets is simply transformed into a concatenated list of <3n> integer values. The newly formed list is then considered as the list of coordinates of a point belonging to a predetermined type of multidimensional SFC. This type is chosen from the list of available multidimensional SFCs. The encryption code of the initial list of RGB codes will therefore be the index of the point belonging to the chosen SFC, whose list of coordinates is known. The encryption key of the list will thus consist of the code itself in a large integer (Bignum) format of the encryption space dimension and the encryption key of the multidimensional SFC.

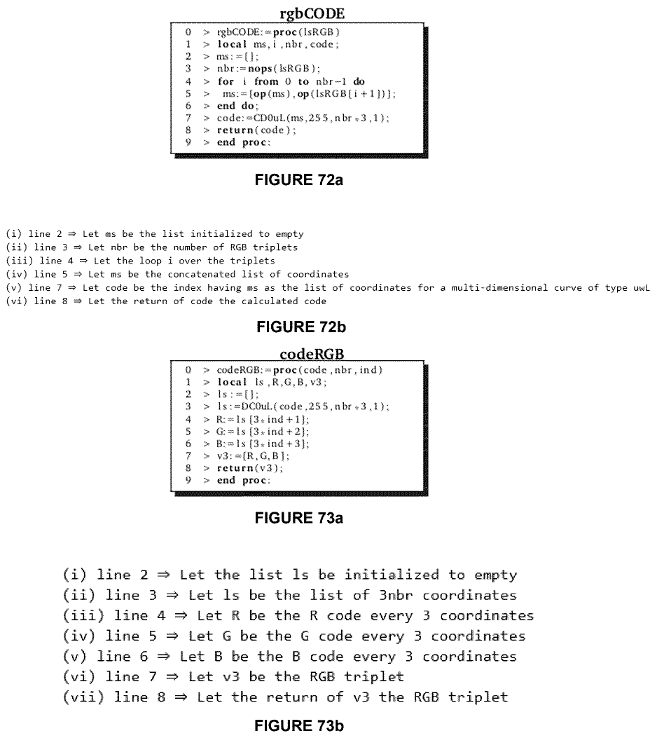

The rgbCODE function in FIG. 72a, explained in FIG. 72b, encodes a list of RGB codes into a multi-precision positive integer (Bignum). The function takes as input the list of RGB codes <lSRGB>. It returns the calculated code.

The codeRGB function in FIG. 73a, explained in FIG. 73b, computes the RGB code of a list of RGB codes encoded from a multidimensional SFC. The function takes as input the code <code>, <nbr> the number of RGB codes in the list, and <ind> the index of the RGB code in the list. The function returns <v3>, the desired RGB code.

### Colorization of Topological Regions

It will be appreciated that the coloring of topological regions is carried out in one or more embodiments using coloring rules associated with densities. The coloring process is therefore associated with the topological partitioning performed from Jordan polygons in one or more embodiments. Densities are algorithmically calculated arithmetic indicators that characterize the combinatorial regions resulting from the partitioning. For each region, the density varies according to the orientation in the plane of each Jordan polygon constituting the partitioning set. The obtained density values fluctuate depending on the number of elementary Jordan polygons constituting the set, and changes in the orientations of these polygons lead to the occurrence of negative densities.

It will be appreciated that the coloring of densities either involves associating an RGB code with each density resulting from the partitioning or associating an RGB code with a set of grouped densities for topological, logical, or other reasons. Grouping densities whose halves are odd, for example, is a strategy that allows differentiating the color of the edges of Jordan polygons from the colors of the interior and exterior regions.

To achieve this, apart from the method of creating a density-color correspondence table, a method for dynamically creating a color palette determined by a limited number of parameters and automatically adapting to the encountered density ranges is disclosed.

### Density Ranges

It will be appreciated by the skilled addressee that the density ranges are the set of different densities obtained during topological partitioning. These ranges are known a posteriori by sorting the final list of obtained densities and retaining only one element among the repeated ones. The eight ranges of the sequence Eq.13 result from the partitioning of FIG. 14 with successive modifications of the orientations of the constituent Jordan polygons. In this case, the partitioning is carried out using three elementary constituent Jordan polygons: two squares and one rectangle. There are thus 23 different combinations of orientations of the three polygons, which yield 8 different colorized occurrences of the same partitioning. These combinations are denoted by an n-tuple of binary values representing the orientations of the Jordan polygons. In the case of FIG. 14 at the top left, the colorizations correspond to the successive combinations [0,0,0], [0,0,1], . . . , [1,1,1].

$$[ - 7 , - 6 , - 4 , - 3 , - 2 , 0 , 1 , 2 , 4 ] \qquad ( 13 )$$

$$[ - 4 , - 2 , - 1 , 0 , 1 , 2 , 3 , 4 , 5 , 6 , 8 ]$$

$$[ 0 , 1 , 2 , 3 , 4 , 5 , 6 , 7 , 8 ]$$

$$[ 4 , 6 , 7 , 8 , 9 , 10 , 11 , 12 ]$$

$$[ - 4 , - 3 , - 2 , - 1 , 0 , 1 , 2 , 4 ]$$

$$[ - 4 , - 3 , - 2 , - 1 , 0 , 1 , 2 , 4 ]$$

$$[ 0 , 2 , 3 , 4 , 5 , 6 , 7 , 8 , 9 , 10 , 12$$

$$[ 0 , 2 , 3 , 4 , 5 , 6 , 7 , 8 , 9 , 10 , 12$$

### Post-Correspondence Densities-Colors

The post-correspondence between densities and colors occurs when the range of densities is known in advance, either through discrete preprocessing performed by previously calculating all densities relative to a topological partitioning within a determined display window, or through a method that allows this range to be known in advance by combinatorial deduction. In this case, the origin of the density range can be shifted to zero by a known translation of all densities.

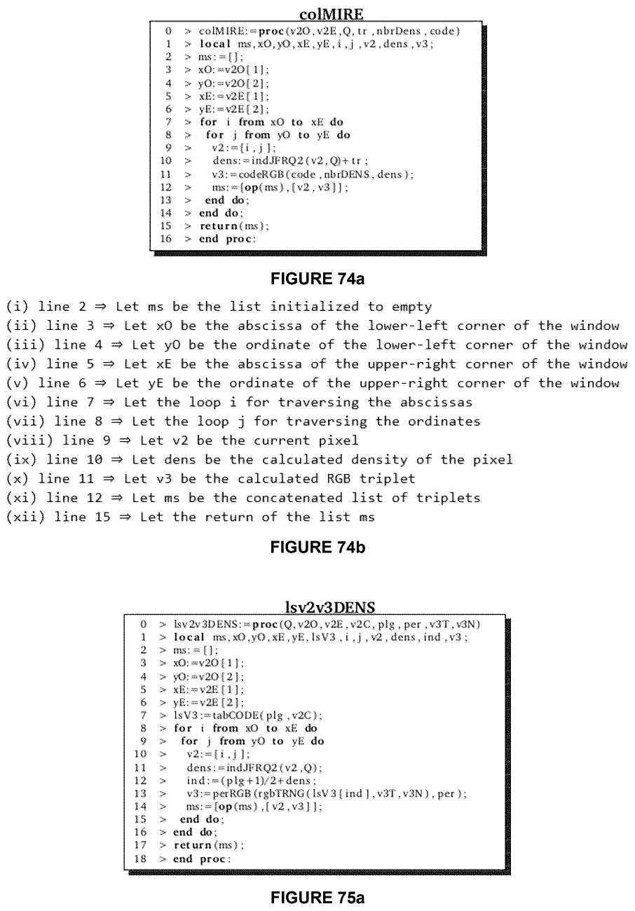

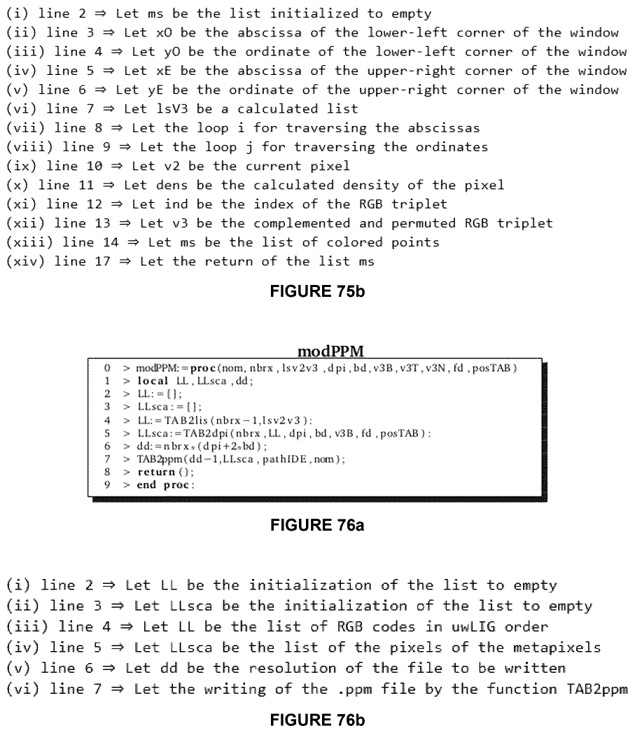

The colMIRE function in FIG. 74a, commented on in FIG. 75b, computes a list of colorized points within a window of known dimensions and for a given topological partitioning. The function takes as input the diagonal points of the scanning window, <v2O> the bottom-left point, <v2E> the top-right point, <Q> the list of quadratic vertices forming the partitioning, <tr> the translation value used to specifically bring the density range to a zero origin and a set of positive values, <nbrDENS> the number of densities in the range, and <code> the integer encoding the list of RGB codes.

### Pre-Matching Densities-Colors

It will be appreciated that the pre-mapping between densities and colors is performed on the fly without prior knowledge of the range of densities. The properties of the tabCODE function already presented (FIG. 66a, FIG. 66b) are used. The principle is to generate a color table where the number of entries will be at least double the absolute value of the maximum density. The color associated with the given density will then simply be the color from the table at the index equal to half the number of colors plus the density value. This approach avoids techniques for hashing sequences of integers with negative values.

The function Isv2v3DENS in FIG. 75a, commented on in FIG. 75b, calculates the list of colored points associated with a set of Jordan polygons represented quadratically. The function takes as input: <Q>, the list of point triplets representing the set; <v2O>, the bottom-left corner of the scan rectangle; <v2E>, the top-right corner of the scan rectangle; <v2C>, the linear combination parameters of the tabCODE function (FIG. 66a, FIG. 66a); <plg>, the number of colors in the defined palette; <per>, the RGB code permutation indicator; <v3T>, the translation vector of the calculated RGB code; and <v3N>, the vector of color complementarity indicators (negative). The function returns the list of colored points in the scan window.

### Examples

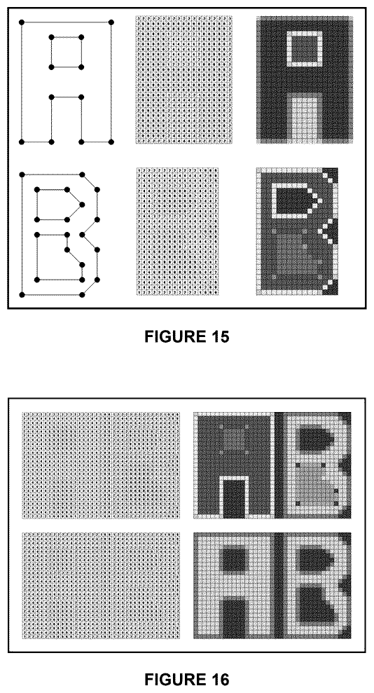

The principles of coloring mentioned earlier are illustrated in FIGS. 15 and 16. The objective is to achieve uniform coloring of the topological partitioning implementing the vector lettering AB. The letter A has two connected components with an orientation code of type [{0,1}, {0,1}], and the letter B has three components with an orientation code of type [{0,1}, {0,1}, {0,1}]. To achieve uniform coloring, a good combination associating the two codes must be identified. In the case of FIG. 16, a good coloring will be achieved using the general code [1,1], [1,0,0] or the complementary code [0,0], [0,1,1]. The code [0,1], [1,0,1] will result in non-uniform coloring of the same figure.

According to step 108 of FIG. 47, the unicellular topological stencil is provided.

It will be appreciated by the skilled addressee that the generated unicellular topological stencil can be provided according to various embodiments. In particular, it will be appreciated by the skilled addressee that the embodiment may depend on the application.

According to one or more embodiments, the generated unicellular topological stencil is stored in a memory unit of the processing device.

According to one or more other embodiments, the generated unicellular topological stencil is transmitted to another processing device operatively connected to the processing device used to implement the method via at least one data network. The skilled addressee will appreciate that the data network may be of various types.

For example, and in accordance with one or more embodiments, the data network may be a local area network (LAN). In one or more other embodiments, the data network is the Internet.

It will be appreciated by the skilled addressee that the step of providing the single-cell topological stencil further comprises, in one or more embodiments, obtaining an SFC or an encoding MCG traversing the square and reordering each point of the single-cell topological stencil using the SFC or the encoding MCG to provide a scrambled single-cell topological stencil, the reordering modifying the coordinates of each point of the single-cell topological stencil such that for each given point with corresponding initial coordinates in a given scan, new coordinates are assigned to this point, these new coordinates corresponding to an identical index in the SFC or in the encoding MCG as an index in the given scan.

It will be appreciated that in the method disclosed in FIG. 47, the information to be encoded is used in at least one of the generation of the partition in a square, the determination of the density associated with each point of the square, and the coloring of each point of the square.

The skilled addressee will appreciate that this use can be done in various ways as numerous parameters are available for each of the steps mentioned above.

### Stencil Scrambling

In fact, it will be appreciated by the skilled addressee that the optional scrambling of topological stencils increases the robustness of encryption against subsequent attacks. It specifically allows for the disruption of the visual coherence of lists of colorized points at both the spatial level of coordinates and the colorimetric level of RGB codes. This scrambling uses a plane reordering approach via SFCs or MCGs. Unlike conventional methods where reordering is performed using a limited number of known SFCs, the transcoding of integers is carried out using MCGs of the same resolution belonging to arbitrary families. The signatures of the MCGs will provide the encryption keys. The following functional scheme (Eq.14) is then obtained:

$${F}_{Cod} ( α ) \to [ x , y ] \qquad ( 14 )$$

$${G}_{Dec} ( [ x , y ] ) \to β$$

$$soit$$

$${T}_{tra} ( α ) = {G}_{Dec} ( {F}_{Cod} ( α ) ) \to β$$

It will be appreciated by the skilled addressee that the decoding and encoding functions <F> and <G> of Equation 3 can be chosen manually or automatically. To select them automatically, it is possible to represent the <n2> combinations of transcoding functions derived from coding and decoding tables with <n> elements by the index in an SFC of resolution <n−1> of the point having as a coordinate pair the index of the decoding function in its table and the index of the encoding function in its table. This index can be used to make a choice via modular hashing.

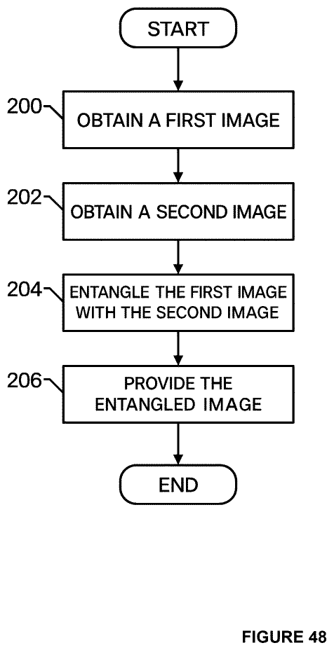

FIG. 48 illustrates a computer-implemented method for encoding information using an image comprising metapixels.

In fact, it will be appreciated that universal graphic identifiers should be able to be displayed on different physical media and through various digital display techniques. The skilled addressee knows that there are two main two-dimensional display methods: the vector method and the bitmap method. The vector method is oriented towards coloring predetermined graphic or geometric primitives: squares, triangles, circles . . . of parameterized size, whereas the bitmap method is oriented towards coloring elementary points called pixels. Unlike the more flexible vector method, the bitmap method has perfect display precision. It will be appreciated by the skilled addressee that in what follows, both approaches will be used, but an overlay is added to the conventional bitmap method by introducing a method developed around the concept of the metapixel. It will be appreciated by the skilled addressee that this approach allows better control of physical printing units such as dpi (dots per inch) but, above all, enriches the limited visual encryption possibilities of the pixel. Metapixels, in particular, allow for visual interleaving of conventional bitmaps such as photographic images and QR codes.

According to step 200 of FIG. 48, a first image with a given number of pixels is obtained.

It will be appreciated by the skilled addressee that the first image can be obtained according to various embodiments. In one or more embodiments, the first image is obtained from the memory of the processing device.

In one or more other embodiments, the first image is generated by the processing device.

According to one or more other embodiments, the first image is received from another processing device via, for example, a data network. The skilled addressee will appreciate that the data network may be of various types.

For example, and in one or more embodiments, the data network is a local area network (LAN). In one or more other embodiments, the data network is the Internet.

It will be appreciated that the first image is selected from a group of images comprising at least one unicellular topological stencil generated using the method described above.

It will be appreciated that in one or more embodiments, the group of images further comprises a tiling generated using a method described herein.

It will be appreciated that in one or more embodiments, the group of images further comprises at least one of a static color table and a dynamic color table.

It will be appreciated that in one or more embodiments, the group of images further comprises a QR code.

It will be appreciated that in one or more embodiments, the group of images further comprises a given image, for example, any imported image (e.g., a photo).

It will be appreciated that in one or more embodiments, the dynamic color table is generated using a method comprising generating a two-dimensional SFC traversing the square and using a hash function to dynamically associate colors from an RGB color cube to each pixel of the square, wherein the association is controlled by the hash function using at least one parameter and the generated SFC. According to step 202 of FIG. 48, a second image having a given number of pixels identical to the given number of pixels of the first image is obtained.

It will be appreciated by the skilled addressee that the second image may be obtained according to various embodiments. In one or more embodiments, the second image is obtained from the memory of the processing device.

According to one or more other embodiments, the second image is generated by the processing device. According to one or more other embodiments, the second image is received from another processing device via, for example, a data network. The skilled addressee will appreciate that the data network may be of various types.

For example, and in accordance with one or more embodiments, the data network may be a local area network (LAN). In one or more other embodiments, the data network is the Internet.

It will be appreciated by the skilled addressee that the second image may be of various types. In fact, the second image may be one of the images mentioned above (e.g., a static color table, a dynamic color table, a given image, a QR code, a generated tiling, a unicellular topological stencil, etc.).

According to step 204 of FIG. 48, the first image is interleaved with the second image to provide an interleaved image. It will be appreciated that the interleaved image includes a given number of metapixels identical to the given number of pixels in the first image.

Each metapixel includes a central portion and a peripheral portion.

The central portion includes at least one pixel with an associated value equal to that of a corresponding pixel in one of the first image and the second image.

The peripheral portion surrounds the central portion and includes a plurality of pixels, each having an associated value equal to that of the corresponding pixel in the other of the first image and the second image.

### Typographic System and Metapixels

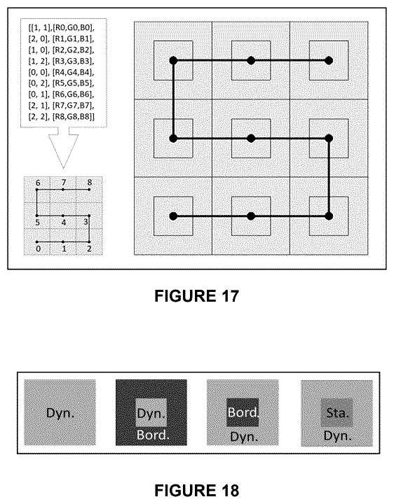

It will be appreciated that the lists of colored points allow associating a pair of coordinates with its corresponding color in the Cartesian plane. This representation makes it possible to describe a bitmap file without prior pixel ordering. To magnify the size of the pixels, the concept of a metapixel is introduced, which transforms a single pixel into a square of n2 pixels, this square itself being divided into an inner square and an outer square. The metapixel principle is essential for changing the physical print resolution expressed in pixels per centimeter but also for creating an additional area for encoding colorimetric information. FIG. 17 illustrates the transition from a pixel representation to a metapixel representation for a simple S-shaped Peano curve. The colors from the list of colored points will be used to color either the inner square or the edges of the square depending on a previously chosen mode.

FIG. 18 illustrates four available typographic modes associated with metapixels. The first mode applies to metapixels without a border. The main square is colored using a dynamic color table. The next mode (fd=0) allows assigning a border thickness and a constant color. In this case, the inner square is colored with the dynamic color table. The following mode (fd=1) reverses the color assignment compared to the previous mode. Finally, the last mode (fd=2) assigns the color of a static color table to the inner square and the color of the dynamic table to the rest of the metapixel.

### The Typographic Process

The algorithms disclosed aim to produce bitmap images at a certain resolution, expressed, for example, in pixels per centimeter or dots per inch (DPI).

The first algorithmic phase involves transforming the list of colored points into an ordered list of RGB color codes in a reading order similar to a typewriter, from top to bottom and left to right. This type of reading is found in many bitmap formats, particularly the ASCII PPM format. The SFC algorithm used to sequence the list of colored points into the ordered color list is the CDOuwLIG encoding function. The second algorithmic phase involves transforming the list of pixel colors into a list of metapixel colors.

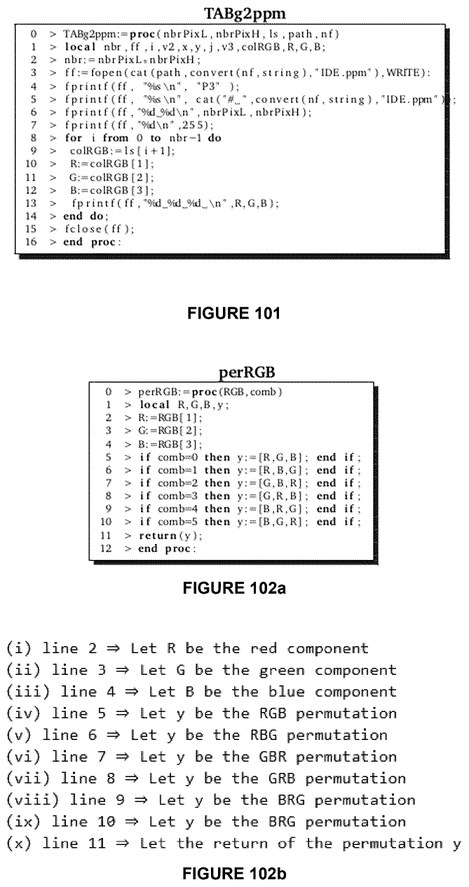

The modPPM function in FIG. 76a, commented in FIG. 76b, takes as input <name>, the name of the bitmap file to generate; <nbrx>, the number of pixels on the side of the print square; <lsv2v3>, the list of colored points, consisting of pairs of Cartesian coordinates of the point and the triplet representing its RGB code; <dpi>, the scale factor of a metapixel; <bd>, the width of a metapixel's border; <v3B>, the RGB color of the border; <v37>, the translation vector for the R, G, B colors; <v3N>, the vector indicating the calculation of the negative image for the three color channels; <fd>, the mode of using the borders and the inner squares of the metapixels; and finally <posTAB>, the color table intended to colorize the inner squares of the metapixels. The function returns the generated file in PPM format through a call to the TABg2ppm function (FIG. 101).

The TABg2lis function in FIG. 100a, explained in FIG. 100b, provides a list of colors ordered according to a top-to-bottom and left-to-right reading. It is the DCOuwLIG function in FIG. 99, an SFC decoding function, that performs such ordering. The function takes as input <a> the resolution of the table of colored points and <ls> the list of colored points. The function returns the ordered list of RGB color codes. This ordering is similar to that of ASCII PPM files.

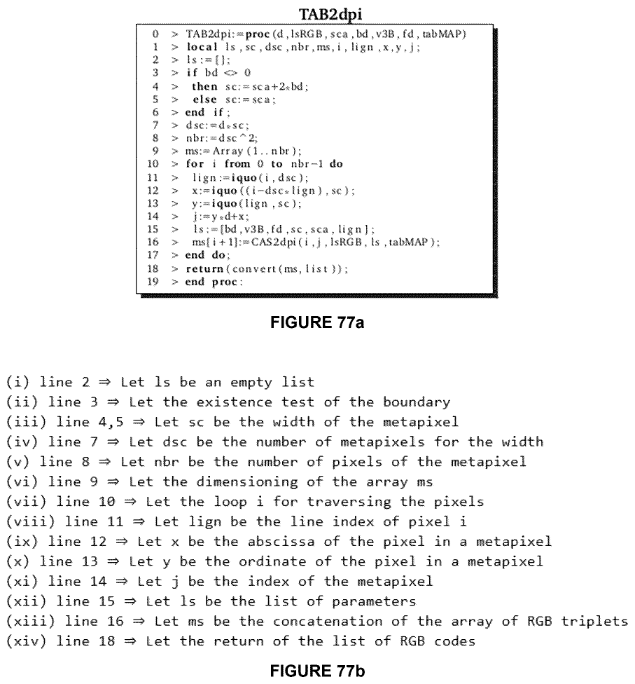

The TAB2dpi function from FIG. 77a, explained in FIG. 77b, calculates the color of a colored metapixel. The function takes as input <d> the size of the metapixel, <lsRGB> the color table, <sca> the scaling factor of the metapixel, <bd> the border thickness, <v3B> the border color code, <fd> the metapixel coloring mode, and <tabMAP> the static color table used to fill the inner squares of the metapixels. The function returns the list of metapixel colors.

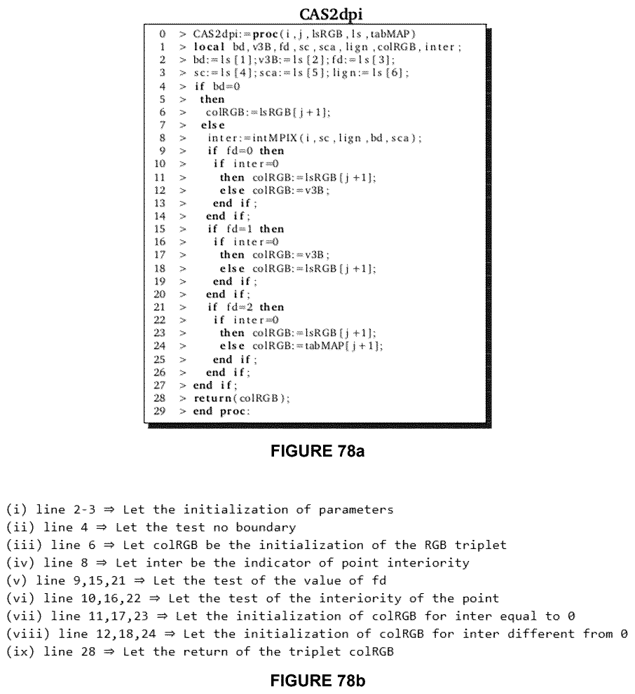

The CAS2dpi function from FIG. 78a, explained in FIG. 78b, calculates the RGB color code associated with a given point. The function takes as input the indices <i> and <j> of the point in the Cartesian plane: its coordinates, the list of colors <lsRGB>, a list of parameters <ls>, and a list of color codes <tabMAP> intended to fill the inner squares of the metapixels. The function returns the determined RGB color code. The function's flowchart follows the typographic mode processing of FIG. 18. The coordinates of the point to be colored are provided as input. If the metapixel border is zero, the point's color is taken from the color table provided as an argument. If the border is non-zero, the status of the point, i.e., its position relative to the inner square of the metapixel, is then tested. From this branching, the tests are conditioned on the modes fd={0, 1, 2}. In mode 2, the color assigned to the point based on its position is either the color determined in the main color table (dynamic table) or the color determined in the image provided as an argument (static table).

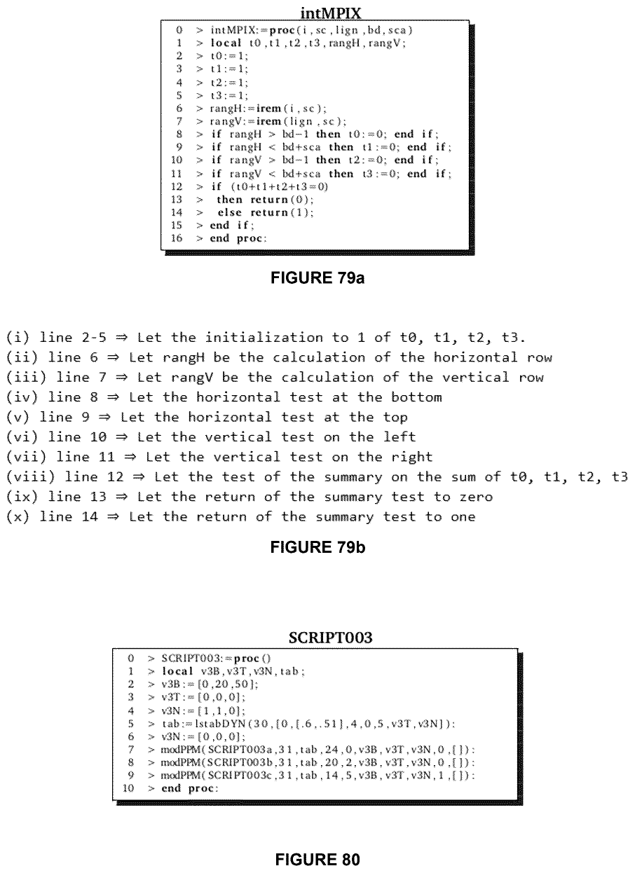

The intMPIX function in FIG. 79a, commented on in FIG. 79b, computes the position of a point relative to the inner square of a metapixel. The function takes as input <i>, <sc>, <lign>, <bd>, and <sca>. The function returns the value 0 or 1 depending on the position of the point in the square.

### Interleaving of Dynamic and Static Color Tables

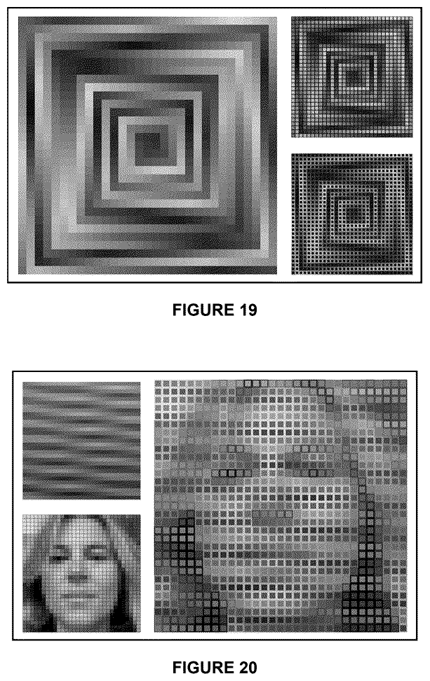

It will be appreciated by the skilled addressee that the interleaving of dynamic tables is valid for the four typographic modes presented above. The SCRIPT003 function in FIG. 80 presents the first three typographic modes applied to a dynamic table illustrated in FIG. 19 on the left. In this case, the metapixel has no border, then a border with a thickness of 2 pixels for an inner square of 20 pixels for the figure at the top right (fd=0), and finally a border of 5 pixels for an inner square of 14 pixels for the figure at the bottom right (fd=1).

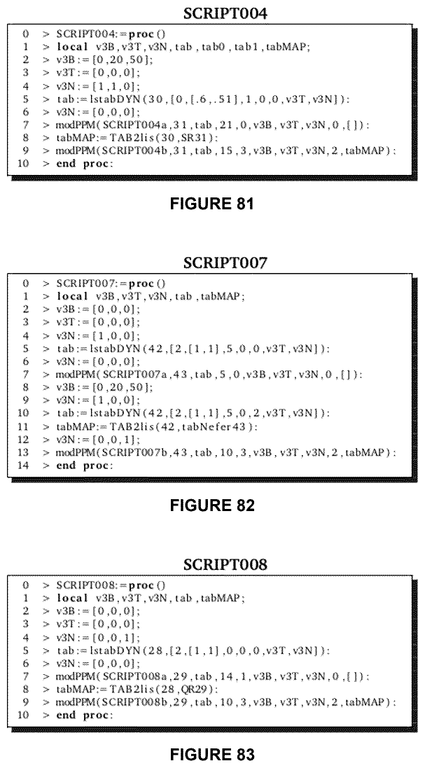

It will be appreciated by the skilled addressee that the nested static tables are precomputed bitmap images of some origin but with a resolution equivalent to the dynamic color table. They can be nested encrypted (scrambled) or not, through elementary or composite SFCs from function tables (the libraries). In the case of photos, the proportion ratio between the edge of the metapixel and the inner square determines the visual reading of the nested bitmap image. FIG. 20 corresponds to the result of the SCRIPT004 script function from FIG. 81. The final image on the right of the figure nests the dynamic color table at the top left and a very low-resolution photo image at the bottom left.

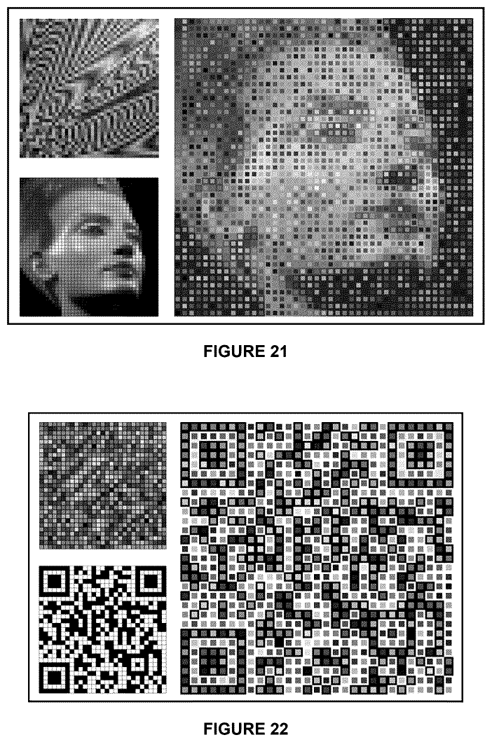

FIG. 21 illustrates a second example of interleaving a dynamic table and a photographic image. The SCRIPT007 function in FIG. 82 is the production script. The alterations of the initial colors of the image of Nefertiti's bust are encrypted along with other parameters in the encryption keys of the resulting bitmap image.

It will be appreciated by the skilled addressee that conventional QR codes can also be embedded into topological stencils using metapixels with the mode fd=2. The SCRIPT008 function in FIG. 83 illustrates an operation of this nature. The text associated with the QR code in this example is “Masahiro Hara, inventor of the QR code.” In principle, the dynamic color table could also be replaced by a second QR code to nest two different codes. FIG. 22 shows the graphical result of nesting a dynamic table at the top left and the QR code in question at the bottom left. The result of the nesting is illustrated by the image on the right.

### Encryption by SFC Scrambling

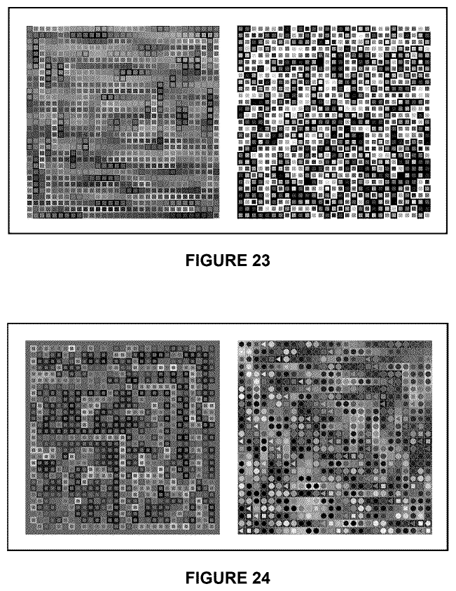

It will be appreciated that the combined use of static and dynamic color tables can notably be intended for identification and authentication. The scrambling of static tables allows adding the visual encryption component to the generated bitmaps. FIG. 23 illustrates the scrambling of photographic static tables and QR code from two of the previous examples. The simultaneous combination of photographic images and scrambled or non-scrambled QR code images is addressed within the framework of multicellular topological stencils.

### Majus Effect

The use of the two square areas defined by the metapixels allows using a set of metapixels to encode two types of colorized information on the same region of the plane. The colorization consistency between the inner and outer regions of the metapixels is advantageously perceptible by the human vision system, which is capable of discriminating two interleaved images.

According to step 206 of FIG. 48, the interleaved image is provided.

It will be appreciated by the skilled addressee that the generated interleaved image can be provided according to various embodiments. In particular, it will be appreciated by the skilled addressee that the embodiment may depend on the application.

According to one or more embodiments, the generated interleaved image is stored in a memory unit of the processing device.

According to one or more other embodiments, the interleaved image is transmitted to another processing device that is operatively connected to the processing device used to implement the method via at least one data network. The skilled addressee will appreciate that the data network may be of various types.

For example, and as part of one or more embodiments, the data network may be a local area network (LAN). In one or more other embodiments, the data network is the Internet.

In one or more embodiments, not illustrated in FIG. 48, the method further comprises a step of obtaining an SFC or an encoding MCG traversing the interleaved image.

The method further comprises reordering each point of the interleaved image using the SFC or the encoding MCG to provide a scrambled single-cell topological stencil, the reordering modifying the coordinates of each point of the interleaved image such that for each given point with initial corresponding coordinates in a given scan, new coordinates are assigned to this point, these new coordinates corresponding to an identical index in the SFC or in the encoding MCG as an index in the given scan; the reordering enabling the provision of a scrambled interleaved image.

The skilled addressee will appreciate that providing a scrambled interleaved image can be of great interest for certain encryption-related applications.

### Encryption of Unicellular Topological Stencils

As mentioned above, unicellular topological stencils are graphical identifiers constructed from SFCs that partition squares in the plane and dynamic color tables that allow coloring the regions partitioned by the SFCs. The partitioning is achieved using one or more SFCs combined topologically. It will be appreciated by the skilled addressee that SFCs can also be used to encrypt color tables. A unicellular topological stencil is therefore described by a series of parameters providing its cryptographic signature. This consists in particular of the encryption keys for each SFC involved in the topological partitioning and the encryption keys associated with the color tables in one or more implementations.

### Cryptographic Signature

In such embodiments, the cryptographic signature of a unicellular topological stencil (Eq.15) is therefore the set of cryptographic signatures of the partitioning SFCs and those associated with the color tables.

$${K}_{cel} = \{ {𝒦}_{Sfc} , {𝒦}_{Tab} \} \qquad ( 15 )$$

$$avec {𝓀}_{Sfc} = \{ {K}_{scf 0} , {K}_{sfc 1} , … \}$$

$$et {𝒦}_{Tab} = \{ {K}_{α} , {K}_{β} , … \}$$

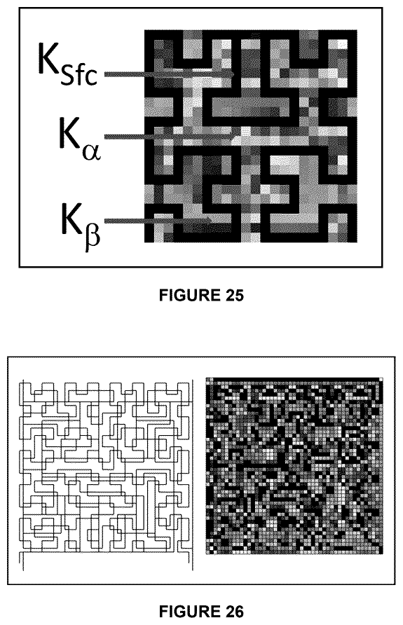

FIG. 25 illustrates a topological stencil constructed from a single SFC: a Hilbert curve, two dynamic color tables for the inside and outside of the curve, and a color table for the edges, initialized in this case to produce a constant black color.

### Multiple Jordan Partitioning

The quadratic representation of Jordan polygons allows merging simple polygons into multiply connected polygons, and then these with other polygons of any connectivity. This property enables combinatorial partitioning that increases in complexity with each addition of new polygons. The number of different density values also increases, and consequently, associating a color table per density value can be done by defining a table per value or by using hash tables. FIG. 26 illustrates a multiple topological partitioning with three Jordan curves.

### Algorithmic Construction Steps

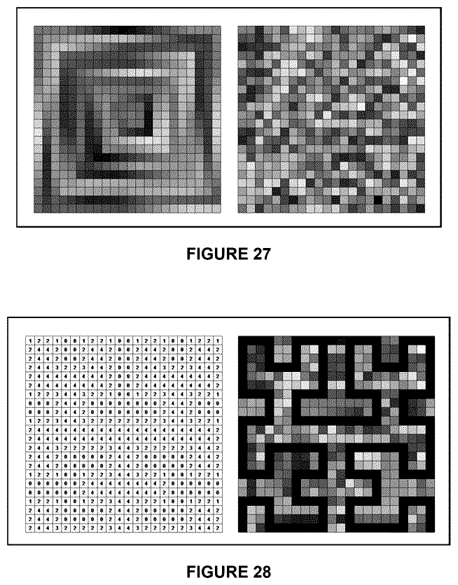

It will be appreciated by the skilled addressee that to construct the stencil, one must begin with a step of determining the color tables, i.e., their respective SFC directrix curve and the choice of coloring parameters forming the cryptographic signature of each table. In the example of FIG. 27, there are two color tables generated corresponding to the coloring of two different topological regions induced by two different SFCs. Given the choice of encryption parameters, the SFC in the figure on the left is discernible, unlike the SFC directrix curve in the figure on the right.

The correspondence between the colored points of the tables and the points positioned relative to the partitioning SFC is established through the densities calculated for all the points of the square containing the SFC. In the example in FIG. 28, the density table on the left of the figure shows density points with values 0, 1, 2, 3, 4. The densities of the edges, i.e., the points located on the sides and the convex and concave vertices, have respective values of 2, 1, 3, while the densities with values 0 and 4 are associated with the points of the interior and exterior regions of the Hilbert curve closed in a Jordan polygon. The correspondence between the densities and the colors is achieved through hash tables with a variable number of entries.

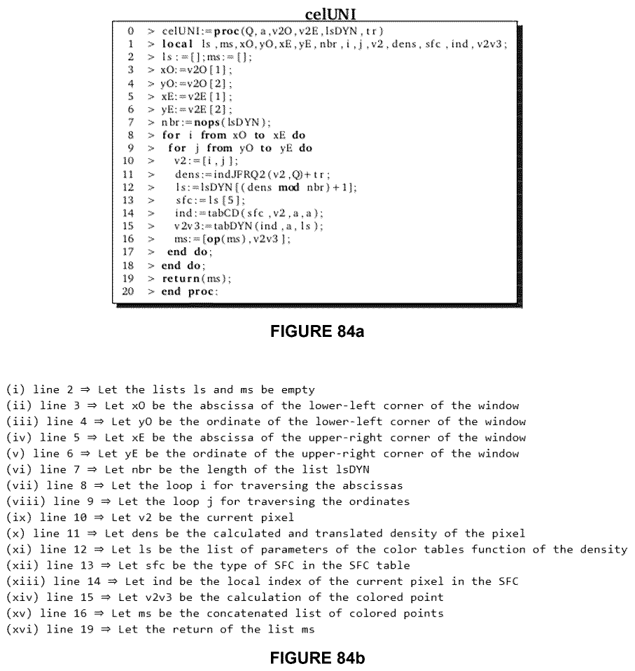

The celUNI function in FIG. 84a, explained in FIG. 84b, calculates a list of colored points within a given square. The function expects as input the quadratic representation <Q> of the set of vertices of all the SFCs used for the square's partition, the bottom-left point of the so-called scanning square <v2O>, and the top-right point <v2E>. The function returns the list <ms> of colored points.

### Dynamic Table Hashing

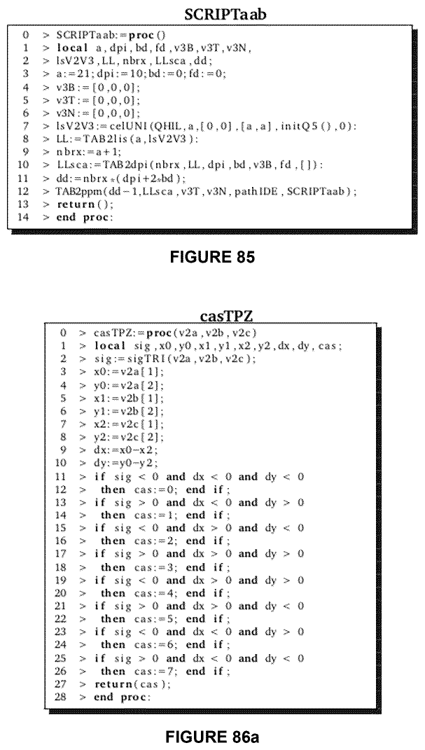

Dynamic color tables are grouped into hash tables. The mapping between a density is done modularly in the celUNI function (FIG. 84a, FIG. 84b) based on the number of entries in the hash table and the density values. The SCRIPTaab script function in FIG. 85 produces the image on the right of FIG. 28. The initialization of three hash tables is illustrated in FIG. 30. Two examples of tables with five entries and one example of a table with thirteen entries are shown.

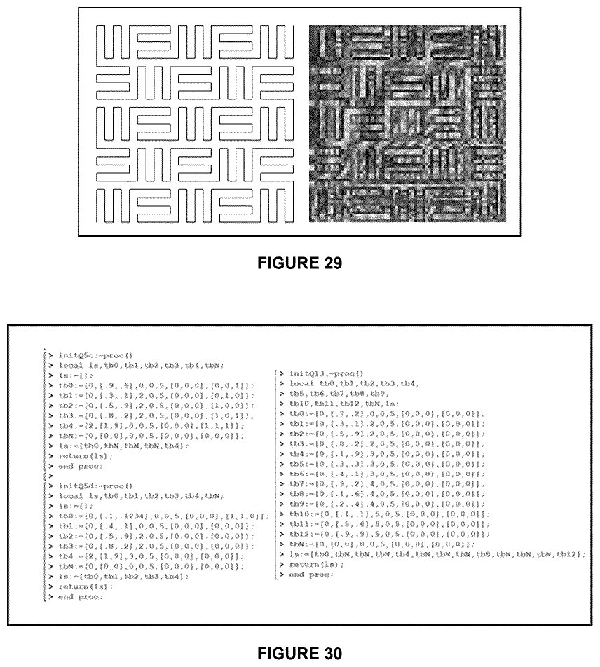

It will be appreciated by the skilled addressee that different hash tables can ultimately be associated with different density regions or grouped based on specific density values. FIG. 29 illustrates an association of different density values with different dynamic tables. In this case, edges are more difficult to distinguish by the eye than when a dynamic table is used to generate a constant color, such as black.

Single-Cell Topological Stencil with Majus Effect

It will be appreciated by the skilled addressee that the Majus effect, associated with the colorization of the inner squares of metapixels and presented below, can be used with any static or dynamic color table. One of the benefits of this operation is the ability to separate the processes of visual identification and authentication. As in the previous examples, all the tables used can be scrambled with substitutions of the SFC directrix curves, resulting in permutations of the colorized points.

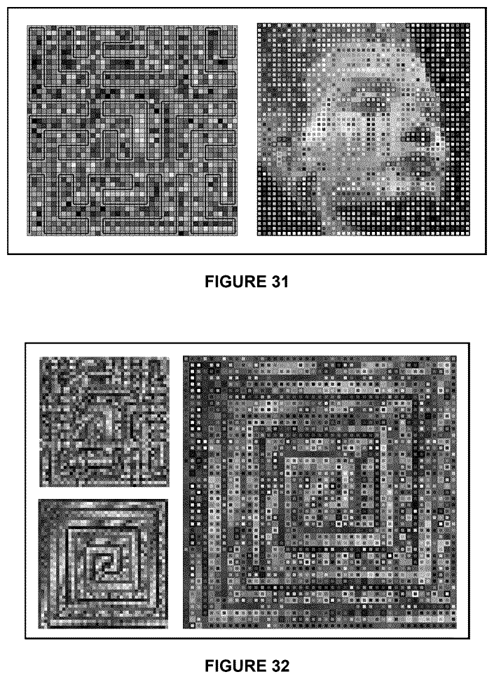

FIG. 31 illustrates a Majus effect created from a digital photo. The visual readability of the photo depends on the proportions between the edges of the metapixels and the inner squares.

FIG. 32 illustrates a Majus effect created from a precomputed or public dynamic table. The addition of symbols or graphic shapes (circle, triangle, polygon) can enable the creation of a graphic code alphabet associated with a given numerical base and, in this case, encode text based on the definition of a SFC directrix curve. However, while vector display from standard graphic languages automatically adapts to the available pixel resolution—pixels fill the vector areas—the equivalent bitmap display, where pixels form the colored areas, is complex to implement and must rely on the principle of a graphic grid defined below.

### Octal Multicellular Partitioning

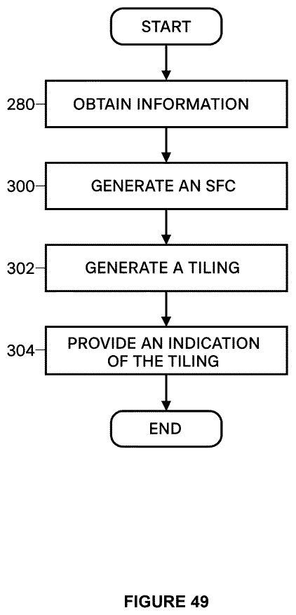

It will be appreciated that there is disclosed a computer-implemented method for encoding information using a tiling generated in a square in FIG. 49.

According to step 280 of FIG. 49, information to be encoded is obtained. It will be appreciated by the skilled addressee that the nature of the information to be encoded can vary.

Furthermore, it will also be appreciated by the skilled addressee that the information to be encoded may be obtained according to various embodiments. In one or more embodiments, the information is obtained from the computer performing the processing. In one or more other embodiments, the information is obtained via another computer operatively connected to the computer performing the processing. The skilled addressee will appreciate that there are many alternative ways to obtain the information.

According to step 300 of the method for generating a tiling illustrated in FIG. 49, an SFC is generated within a square.

It will be appreciated that the SFC can be generated according to various embodiments.

According to step 302 of the method for generating a tiling illustrated in FIG. 49, a tiling is generated. The tiling is generated by replacing each elementary portion of the SFC with a corresponding tiling.

According to step 304 of the method for generating a tiling illustrated in FIG. 49, an indication of the generated tiling is provided.

It will be appreciated that the method is characterized in that the information to be encoded is used during the generation of the SFC in step 300. In fact, the information can be used to generate parameters for generating the SFC. The skilled addressee will appreciate that said information to be encoded can be used in various ways.

In fact, it will be appreciated that in one or more embodiments, the SFC is defined by 8 elementary portions in “S”. In this or these embodiments, the corresponding tiling corresponds to a given identical and fixed tiling for each of the 8 elementary portions.

In one or more embodiments of the method for generating a tiling in a square, the method further comprises obtaining an ASCII string to encode. The method further comprises converting the obtained ASCII string into a sequence of corresponding codes in a given numerical base filling a square array and generating an SFC using a given Gray SFC directrix curve in which each point of the Gray SFC directrix curve is replaced by a pattern corresponding to a given code from the sequence of codes.

It will be appreciated by the skilled addressee that multicellular partitioning aims to increase the complexity of visual encryption of topological stencils by partitioning each cell of the plane. It will be appreciated that a cell is a square subdivision of the plane, forming a perfect square with other identical cells. In this case, the ordering of the cells follows a predetermined SFC directrix curve. The possibility of generally associating a topological partitioning per cell of the plane requires multiplying encryption keys: one set per cell, a relatively heavy process to implement. The solution disclosed involves setting up an automatic multicellular partitioning dependent on the vertices of the guiding SFC of the cells.

### General Principles

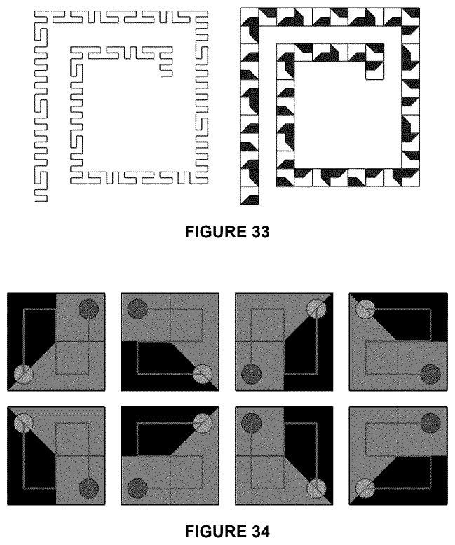

As mentioned above, the principle of topological stencil involves, in one or more embodiments, a partitioning of the plane by Jordan polygons, including as a particular case SFCs after their topological closure. The previously presented topological stencils are unicellular in nature, meaning that a single square of the plane is colored based on parameters (the cryptographic signature) associated with it. In the following, the notion of multicellular partitioning, which enables encryption using a set of squares called cells filling a main square of the plane, is disclosed. This set of cells is determined by a SFC directrix curve derived from the available libraries of elementary or composite MCG SFCs. An example of topological partitioning based on a set of two trapezoids and a square per cell in octal base and two triangles in quaternary base (Truchet tiling) is then disclosed. This set of polygons is centered on each vertex of the SFC directrix curve, which in this case is a composite SFC or MCG curve based on elementary Peano curves. The set of polygons is oriented according to the orientation of the elementary curves associated with the cells. FIG. 33 illustrates the iterative construction of a spiral SFC controlling, for each of its vertices, a cell composed of two trapezoids and a square (base 8). The orientation of the polygons depends on the elementary Peano curve in an S-shape filling the cell (left figure).

The existing geometric relationships between the polygons and the curves of the cells form the basis of a new system of tiling and topological partitioning of the plane detailed below.

### Peano-Truchet Tilings

It will be appreciated that the Truchet tiling is a tiling of the plane made from a set of elementary squares divided into two triangles of different colors. There are thus four possible combinations of colored squares, which constitute a quaternary coding of the plane. A hybrid algorithmic coding system based on the MCG extension of Peano coupling functions and Truchet tiling theory is described. The principle is to associate eight elementary graphic matrices with the eight configurations of the elementary S-shaped and oriented Peano curve. This approach amounts to defining a new type of tiling in the plane, which will be named Peano-Truchet tiling. The eight graphic matrices are thus named Peano-Truchet patterns and are illustrated in FIG. 34.

As mentioned above, it will be appreciated that in one or more embodiments, the SFC is defined by 8 elementary “S” portions. In this or these embodiments, the corresponding tiling corresponds to a given, identical, and fixed tiling for each of the 8 elementary portions.

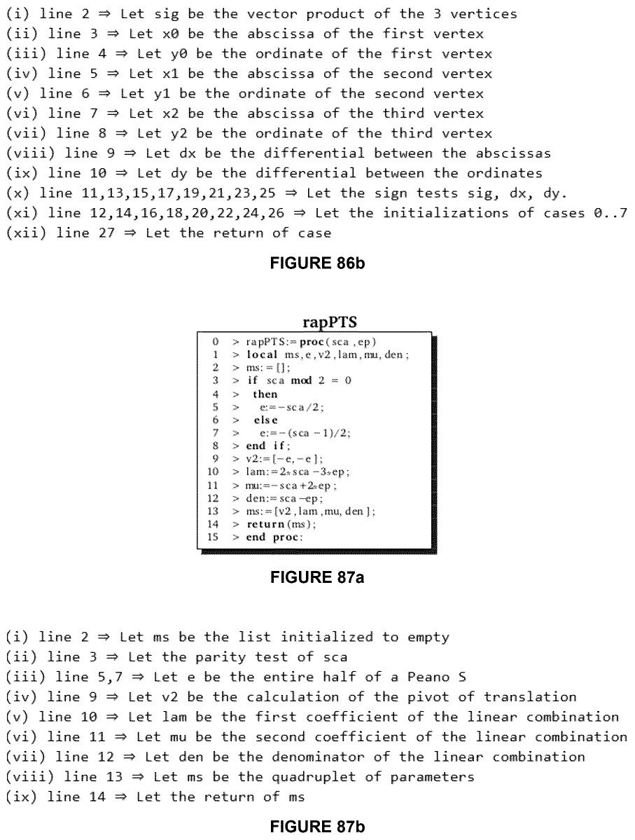

The cas TPZ function in FIG. 86a, commented on in FIG. 86b, aims to classify the eight possible Peano-Truchet pattern types. The function expects as input <v2a>, <v2b>, <v2c>, the three reference points of each elementary Peano curve. The function returns the case number associated among the eight presented in FIG. 34, with the cases being respectively 0, 2, 4, 6 for the configurations in the first row and 1, 3, 5, 7 for the second row.

### Algorithmic Construction of the Tiling

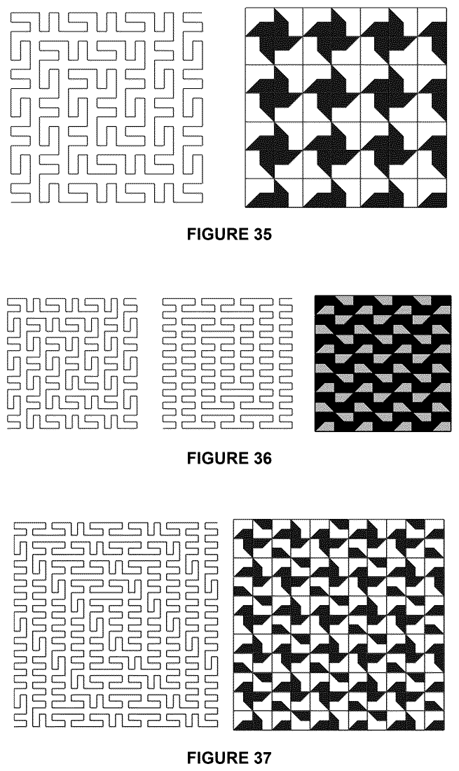

The algorithmic generation of the Gray metacurve, composed of elementary S-curve segments, is based on level-2 Gray metacurves that introduce symmetry for all rotors. Regular or notable tilings can be generated by activating or deactivating symmetries. FIG. 35 illustrates the direct generation of a regular octal tiling from a generating Gray metacurve of type wS (W-class spiral).

It will be appreciated by the skilled addressee that other types of regular or notable tilings can be generated by activating symmetries either on even rotors or odd rotors, sequentially or in isolation. FIG. 36 illustrates the generation of a regular tiling after algorithmic modification of the symmetries of each S-curve.

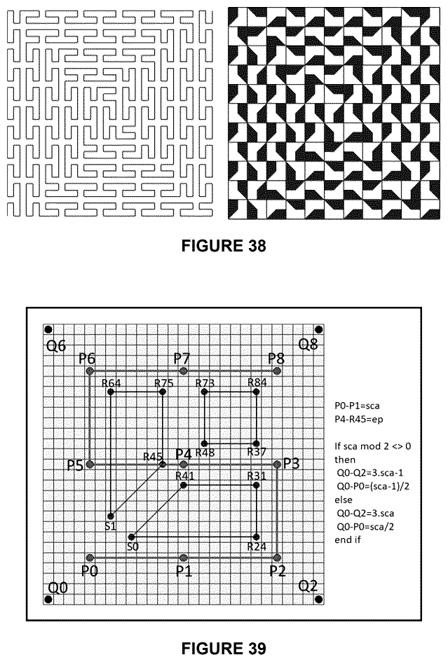

The call to the function DC2(i,2,[6,2],[11],[[ ],[seq(2*i,i=1 . . . 24)]]) thus allows changing the symmetry of the even-order 1 rotors of the Gray metacurve illustrated on the left of FIG. 36. The metacurve resulting after the application of the symmetries is illustrated in the middle of FIG. 36 and enables the generation of the regular Peano-Truchet octal tiling illustrated on the right of the Figure. FIG. 37 is obtained from a MCG of type DC2(i,2,[6,2],[11]). FIG. 38 illustrates the choice of symmetries of the elementary S curves of the spiral MCG on the left of the Figure to obtain the octal combinatorial spiral structure on the right of the Figure.

### Vector and Bitmap Typographies

It will be appreciated that the previous illustrations are created using vector graphic packages employing graphic primitives such as colored polygons. This approach must be complemented by a bitmap approach requiring precise calculations without pixel-level approximations. Bitmap outputs are particularly necessary for typographic editions on physical media. Furthermore, the physical decoding through image analysis of multicellular topological stencils requires reference points in the stencil that will be associated with a polygonal target. The proportions and measurements of this type of calibration target are illustrated in FIG. 39 and thus meet the dual requirement of pixel precision for stencil editing and polygonal pattern recognition per cell. This calibration target is calculated from a parameterized canvas of control points that allow generating the base-8 calibration target composed of two trapezoids and a square, and the base-4 calibration target composed of two triangles. This calibration target principle can be extended to discretely encode polygonal symbols and graphic shapes from FIG. 32 or any other graphic pattern based on the control points.

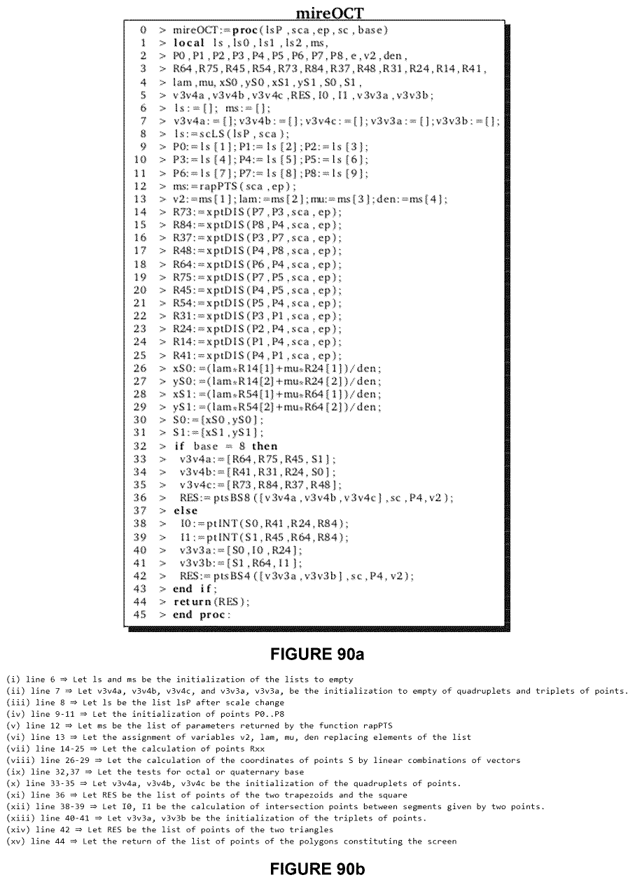

The mireOCT function in FIG. 90a, explained in FIG. 90b, calculates the set of coordinates for the polygonal target within a square cell. Control parameters allow modifying the base-8 proportions of the three polygons involved: the two trapezoids and the square, as well as the base-4 proportions of the two triangles. The function takes as input the list <lsP> of control point coordinates for each S-curve, <sca>, a global scaling parameter for the main SFC directrix curve, <ep>, the pixel thickness between the polygons, <sc>, the local scaling of the polygons within the cell, and <base>, the base used for generating the calibration target. The function returns the lists <TPZ0>, <TPZ1>, and <CR> of point coordinates for the two trapezoids and the square, or the lists <TR0>, <TR1> of point coordinates for the two triangles.

This function uses an initial auxiliary function rapPTS from FIG. 87a, commented in FIG. 87b, which provides the coordinates of a point linearly dependent on two given points. The set of linear dependencies of the calibration target is calculated in this way based on two control parameters. The function takes as input the parameters <sca> and <ep> previously defined in the mireOCT function (FIG. 90a, FIG. 90b) and outputs a list containing the point with the coordinate pair <v2> and the calculation parameters of the linear dependencies <lam>, <mu>, and <den>.

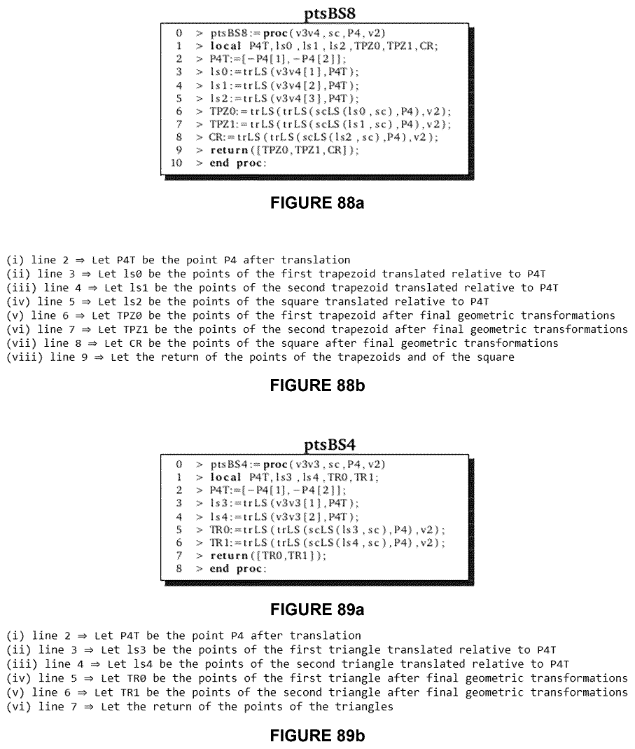

This function uses two other auxiliary functions, ptsBS8 from FIG. 88a commented in FIG. 88b and ptsBS4 from FIG. 89a commented in FIG. 89b, which calculate the points of the respective polygons of the calibration target in base 8 or base 4 from the control points. These functions, in turn, call two additional auxiliary functions (named trLS and scLS) that perform translations and scaling on the coordinate pairs of lists, respectively.

The ptsBS8 function (FIG. 88a, FIG. 88b) positions the trapezoids and the square in the processing cell's reference frame. The function expects as input the list of lists of the coordinates of the three polygons <v3v4>, the scaling factor <sc>, the central point of the Peano curve <P4>, and the point with the coordinate pair <v2>.

The function ptsBS4 (FIG. 89a, FIG. 89b) positions the two triangles in the reference frame of the processing cell. The function takes as input the list of lists of coordinates of the two polygons <v3v3>, the scale factor <sc>, the central point of the Peano curve <P4>, and the point with the coordinate pair <v2>.

The function mireOCT (FIG. 90a, FIG. 90b) uses a final auxiliary function (named ptINT) that calculates the intersection point of two lines, each defined by two points.

### Octal Multicellular Encryption

It will be appreciated that integrating text into visual identifiers such as barcodes, QR codes, or data matrices produces results readable by hardware or software decoders. It will be appreciated that the issue of combining a triple response—technological and visual—to the problem of identification, authentication, and encryption is not resolved in this case. Since the human eye cannot discriminate and interpret visual information, the graphical encoding of barcode technologies serves only to enable the quick visual localization of the code in question for subsequent proper hardware decoding. Octal multicellular encryption aims to combine patterns, motifs, and visual signatures with text encoding. While text decoding is always entrusted to hardware or software decoders, the identification and authentication part is partially reliant on human vision.

### General Principles

It will be appreciated that octal multicellular encryption aims to transform geometric octal tilings into colorized visual identifiers. Two approaches are disclosed. A first fully graphical approach leveraging color interleaving applied to all octal cells, and a second alphanumeric approach using octal cells to encode text. Octal encryption enables the creation of quaternary multicellular encryption through some algorithmic modifications.

### Cryptographic Signature

The cryptographic signature of a topological stencil with octal or quaternary multicellular encryption consists of a set of integer numerical parameters, a list of quadratic vertices, and encryption keys for color table mappings. It takes the following form:

$${K}_{a} = \{ ℬ , ℒ , 𝒜 , {𝒦}_{α} , {𝒦}_{β} , {𝒦}_{γ} , Sca , Ep , Sc , Code \} \qquad ( 16 )$$

$$avec ℬ ∷ = 4 \vert 8$$

$$et 𝒜 ∷ = 〈 integer 〉$$

$$et Sca ∷ = 〈 integer 〉$$

$$et Ep ∷ = 〈 integer 〉$$

$$et Sc ∷ = 〈 integer 〉$$

$$et Code ∷ = 〈 integer 〉$$

### Color Table Nesting

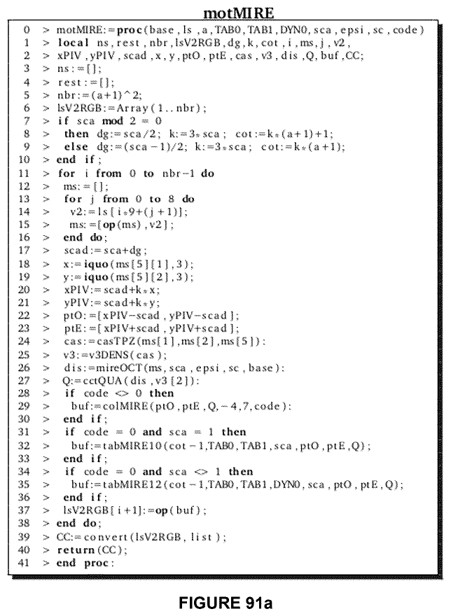

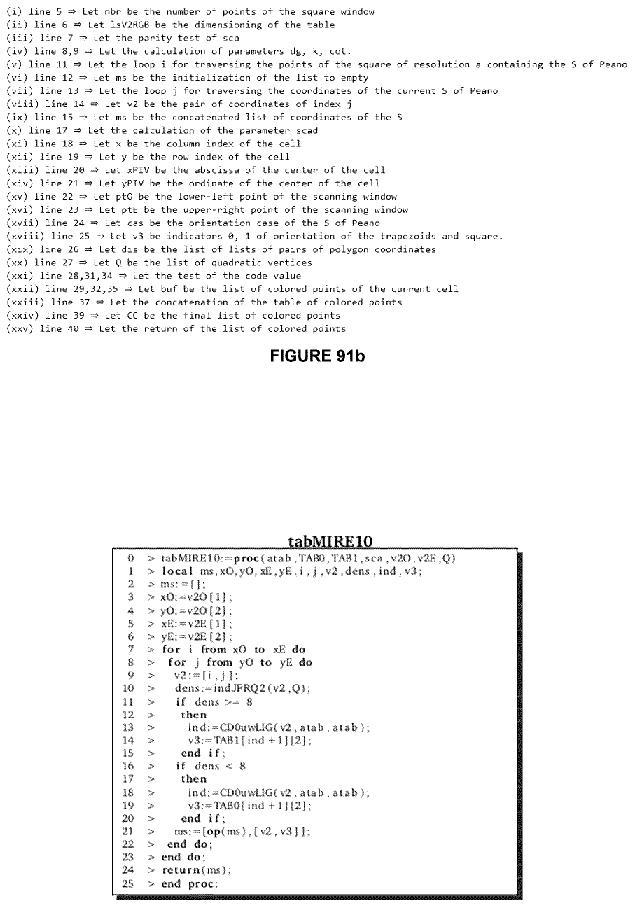

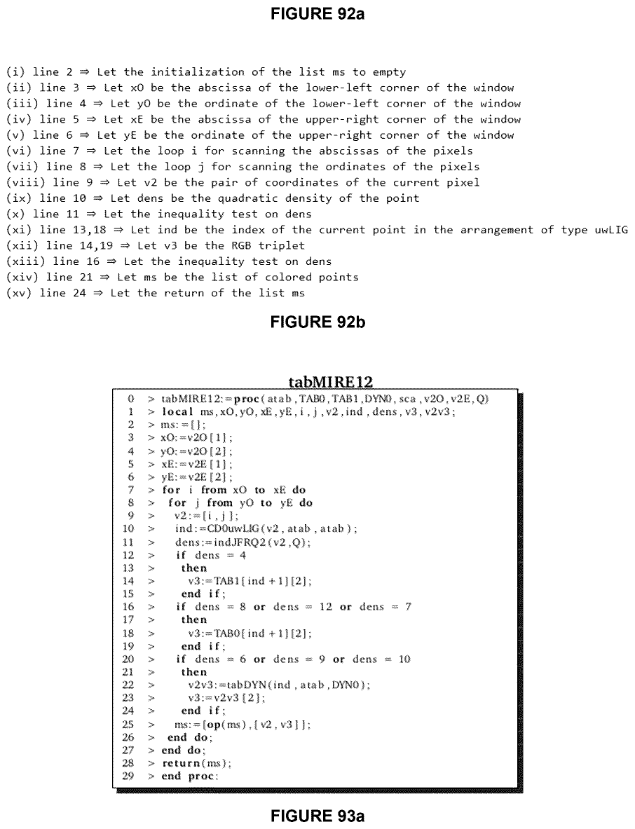

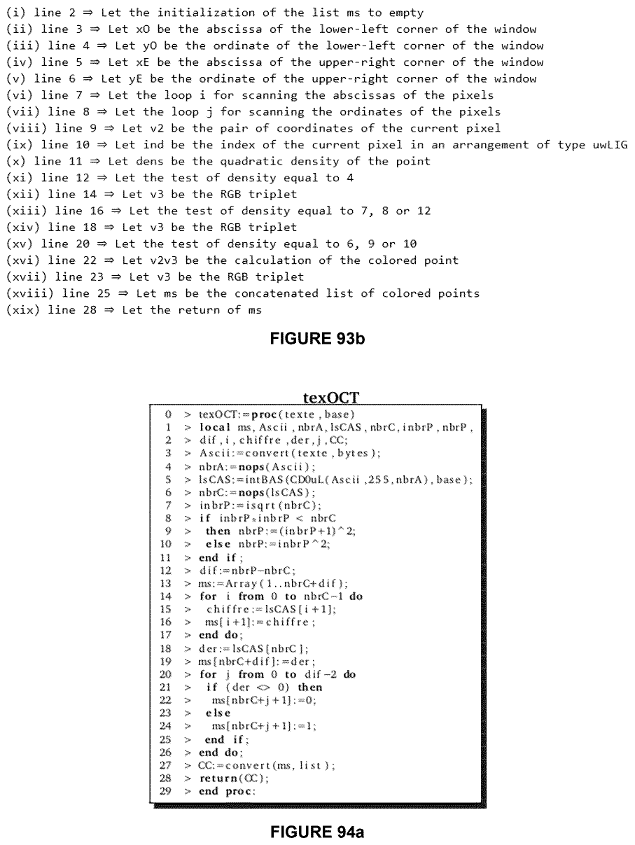

The calibration target in FIG. 39 has, in base 8, 3 connected components, and in base 4, 2 connected components, allowing for different combinations of orientations in the polygon plane that constitutes it and, consequently, the generation of areas with different densities. Subsequently, filters on the densities obtained after topological partitioning are used. These filters group certain densities based on arithmetic predicates≤to establish a strategy for coloring the regions defined by the calibration target. The motMIRE function (FIG. 91a, FIG. 91b) that follows uses three different filter functions associated with the value of certain main parameters of the calibration target. These functions are successively the colMIRE function (FIG. 74a, FIG. 74b), the tabMIRE10 function (FIG. 92a, FIG. 92b), and the tabMIRE12 function (FIG. 93a, FIG. 93b).

The motMIRE function from FIG. 91a, commented in FIG. 91b, calculates the list of colored points for a given SFC curve based on elementary Peano curves in an S shape. The function takes as input <base>, the generation base of the grid with a value of 8 or 4, <ls> the list of SFC points in a multiple of 9, <a> the number of elementary curves minus one of the S curves in the width or height of the square, the color tables <TAB0>, <TAB1>, and <DYN0>, the typographic parameters <sca>, <epsi>, <sc>, and the optional <code> encoding the colors. The function returns the calculated list of colored points.

Peano-Truchet tilings are natively bicolored, but depending on the characteristics of the generating metacurves, they can be generated with more colors. A quadrichromatic example can easily be achieved by using the parity properties of the S curves of the metacurve to color the tiling with 4 colors.

In general, by associating a dynamic color table with the tiling, it is therefore possible to colorize the tiling with as many different colors as the number of tiles in the tiling, and by adding, for example, another color for the trapezoids. The creation of a tiling with a chaotic color table will then involve calculating a kinetic color table that will be associated with the directrix metacurve of the tiling.

The function tabMIRE10 from FIG. 92a, commented on in FIG. 92b, filters densities relative to density 8 and partitions the plane into two topological regions. Each region is associated with a predetermined color table. The function takes as input <atab>, the resolution of the square representing a cell, <TAB0> and <TAB1>, two color tables associated respectively with the two regions, <sca>, the scale factor of the calibration target that controls the resolution of the calibration target in pixels, <v2O> and <v2E>, the diagonal corners of the coloring window, and <Q>, the set of quadratic vertices of the partitioning. The function returns the list of colored points belonging to the coloring window.

The function tabMIRE12 in FIG. 93a, explained in FIG. 93b, filters densities based on three density ranges and partitions the plane into three topological regions. The function takes as input <atab>, the resolution of the square representing a cell, <TAB0> and <TAB1>, two color tables associated respectively with two regions, <DYN0>, the parameters of a dynamic table associated with the third region, <sca>, the scale factor of the calibration target that controls the resolution of the calibration target in pixels, <v2O> and <v2E>, the diagonal corners of the coloring window, and <Q>, the set of quadratic vertices of the partitioning. The function returns the list of colored points belonging to the coloring window.

### Octal Calibration Target

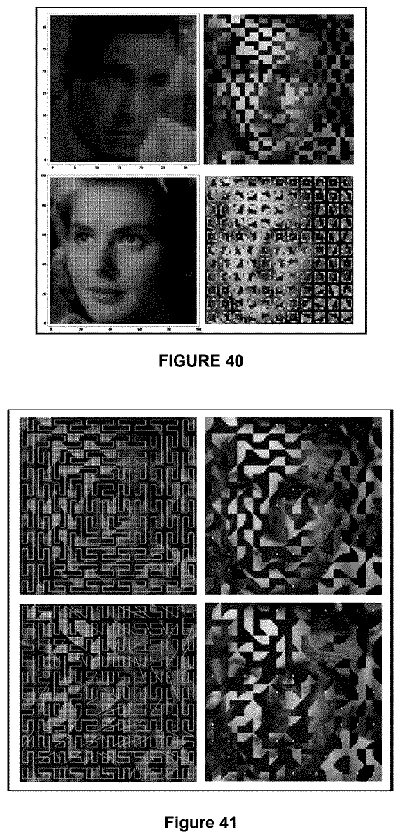

It will be appreciated by the skilled addressee that the calibration of the octal calibration target aims to adjust the calibration target parameters to the desired final image. These parameters determine the visual reading of the final topological stencil as well as its reading by an optical decoding device (hardware and software). FIG. 40 illustrates the generation of a topological stencil for multiple image resolutions used as color tables.

### Octal Alphanumeric Encryption

It will be appreciated by the skilled addressee that alphanumeric octal encryption is a variant of geometric octal encryption designed to control geometric tiling through text. FIG. 41 illustrates the difference, using the same color tables, between a geometric tiling and its associated Gray SFC, and an alphanumeric tiling and its associated non-Gray SFC. In the latter case, the orientations of the polygons in the patterns automatically adapt to text encoding performed in base 8 or 4 from a SFC directrix curve.

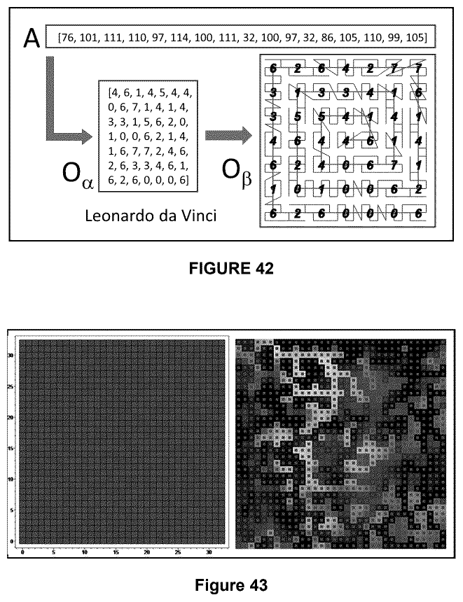

The alphanumeric octal encryption thus transforms a text into a sequence of octal-type patterns encoding the text along a predetermined SFC. This operation, by which the patterns are no longer oriented by the elementary S-curves of their cell but by the octal encoding of the text, will generally destroy the Gray structure of the curve. This loss of Gray coding is illustrated in FIG. 42, which shows the encoding of the message Leonardo da Vinci as an ASCII character list (A), then as a table of octal characters (Oa) ordered like conventional text from top to bottom, and finally as a table of octal characters (Oa) ordered according to a spiral SFC.

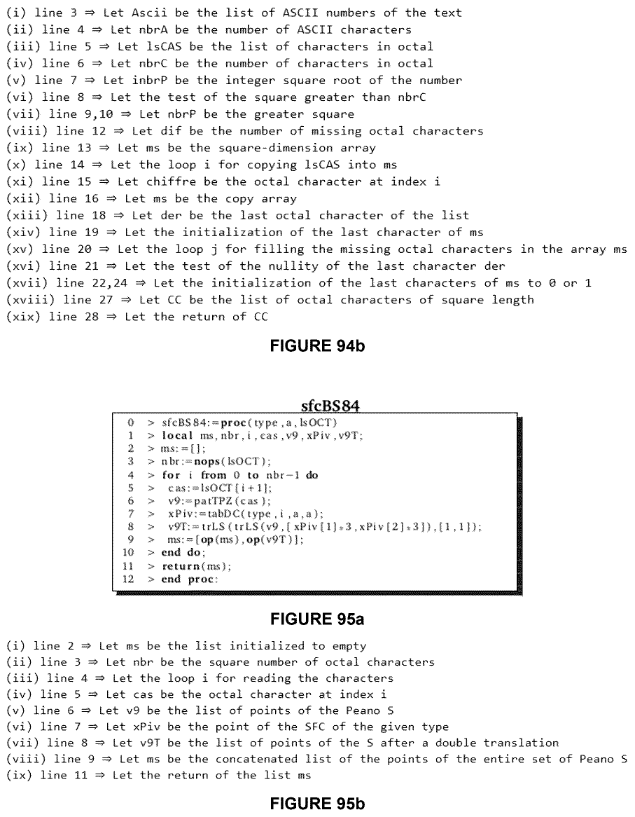

The textOCT function in FIG. 94a, explained in FIG. 94b, transforms an initial text into a sequence of codes in a given numerical base, filling a square array. The algorithm encodes the text and, if necessary, adds a series of characters to fill all the cells of the square array. The function takes as input the text to encode <text> and the encoding base <base>. The function outputs the sequence of codes, where the number of elements is a perfect square.

### SFC Directrix Curve for Text

The sfcBS84 function in FIG. 95a, explained in FIG. 95b, generates the non-Gray SFC resulting from the encoding text. This SFC, composed of elements of S-shaped Peano curves, itself has a Gray SFC directrix curve. This curve is part of the encryption key for octal or quaternary text. The function takes as input the <type> of the SFC directrix curve, the resolution <a> of the SFC, and <lsOCT>, the list of octal or quaternary characters, as applicable, associated with each point of the SFC. The function returns the list of points of the generated non-Gray SFC.

### Chimera Encryption System

The encryption system titled Chimera, disclosed below, combines an octal or quaternary alphanumeric encryption with a 2ⁿ-ary encryption using the inner squares of the metapixels to encode a message. The message will thus be encoded in the form of sequences of n pixels, for example, n=1 for a binary message. FIG. 43 illustrates a graphical identifier encoded with a Chimera protocol, using two photographic images as color tables and a binary bitmap matrix as the third color table.

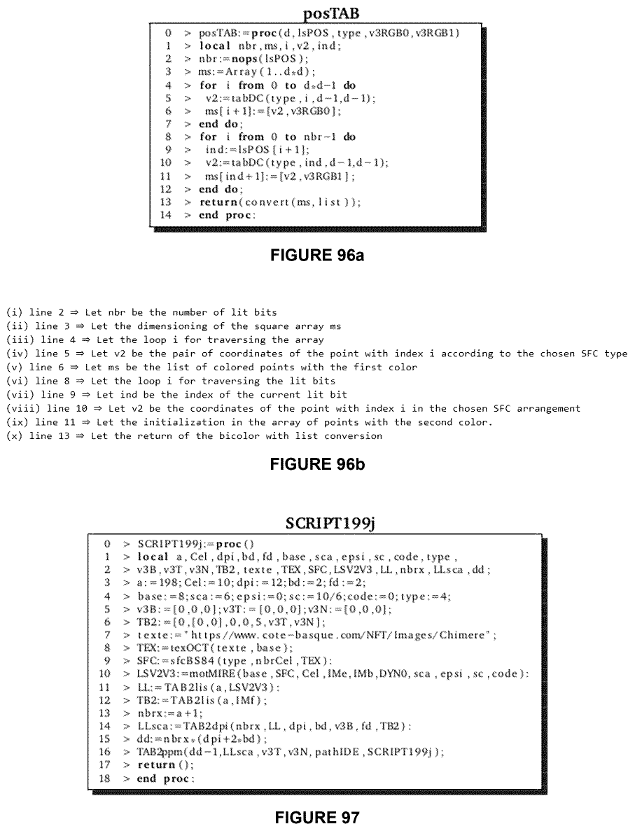

The posTAB function in FIG. 96a, commented on in FIG. 96b, takes as input <d>, the number of pixels on the side of the square containing the message, <lsPOS>, the list of sequential positions of the lit bits, <type>, the type of SFC bit ordering in the plane, <v3RGB0> and <v3RGB1>, the RGB color codes of the binary points. The function outputs <ms>, the list of colorized points.

### Adaptation to Quaternary Encryption

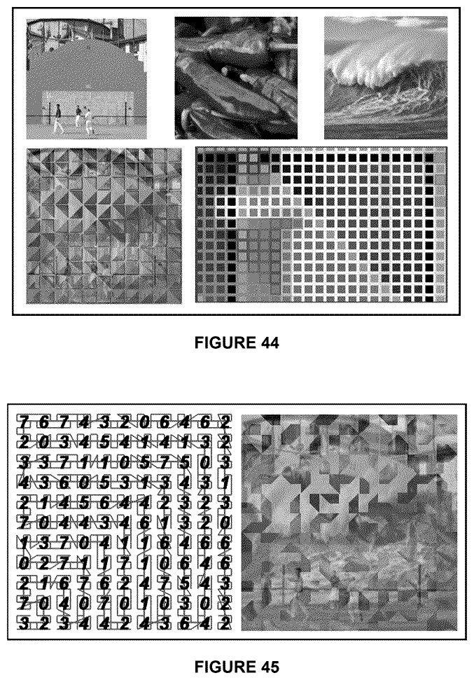

It will be appreciated by the skilled addressee that it is possible to substitute a quaternary encryption for the octal encryption. The principle is to specialize the octal grid to operate in quaternary mode. The calculation functions for the two triangles of the grid have been described in the ptsBS4 function (FIG. 89a, FIG. 89b). The rest of the process for a quaternary topological stencil is otherwise entirely similar to that of the process concerning the octal stencil. FIG. 44 illustrates the generation of a quaternary stencil composed of three color tables corresponding to the three images at the top of the figure. The images have a resolution of 199×199. The quaternary message “https//www.cote-basque.com” is ordered by the same spiral SFC as in FIG. 42. The bottom-left image provides a visual result that can be adjusted based on the parameters associated with the metapixels. The readability of the three photographic components can thus be modulated. The bottom-right image allows for visualizing a magnification of the metapixels on a portion of the bottom-left image.

### Summary Example

A summary example of the Chimera encryption system is presented. The example of image interleaving from FIG. 44 to switch to an octal encryption mode is revisited. The following text “https//www.cote-basque.com/NFT/Images/Chimere” is encoded. All parameters and the sequence of operations to generate the final topological stencil are described in the SCRIPT199j function from FIG. 97.

The visual result is illustrated in FIG. 45. The left image represents the octal characters of the text positioned on their SFC directrix curve, while the right image shows the final stencil result.

### Ordering in the Plane

The use of lists of colored points, specifying the position of each point by its Cartesian coordinates and its RGB code, allows any digital image to be communicated explicitly. With this approach, the relative ordering of points with respect to each other does not need to be specified. The downside of this approach is the prohibitive memory size of the image that needs to be communicated. For this reason, implicit communication approaches are favored. In this case, a predetermined ordering of the colored points is applied both to the storage of the color list and reapplied during the use of the colors, for example, their display. The algorithmic ordering process frequently chosen for digital graphic standards uses a typewriter-like reading, from top to bottom and left to right. This process is equivalent to the implicit choice, for data reading and rendering, of a SFC directrix curve for the ordering. The issue encountered, therefore, across all the presented works, is to specify and explicitly communicate the SFCs used in the plane's ordering through encryption keys.

### General Principles

It will be appreciated that the ordering principle of the plane is the systematic use of the SFCs provided in the coupling tables and libraries and transmitted in the encryption keys. In this case, the encryption key of the SFC itself will be the parameters allowing it to be generated and thus encoded and decoded. This approach will present another advantage because any substitution of a storage SFC with a different reading SFC will result in scrambling the image. This strategy will be used to complicate cryptographic attacks on communicated images or to allow their reading by specific rights holders.

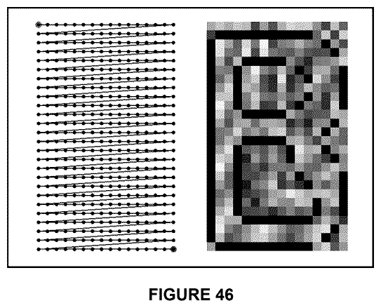

FIG. 46 illustrates the convention for storing and reading a color image in ASCII PPM format. The plane ordering is OXY− instead of the classic OXY ordering. The color tables used to colorize the letter B, having been generated from arbitrary SFC directrix curves different from the SFC directrix curves of the PPM format, must be converted between the SFCs to bring each pair of coordinates into its ordering space in the Cartesian discrete ordering space.

### Plane Ordering OXY−

The printing of pixels and colorized metapixels in an OXY− plane is often necessary to comply with certain graphic standards. This is the case for the PPM format, which is defined by an ordering of colors starting from an origin located at the top left, with an inverted Y-axis. The principle is therefore to reorder a list of colors associated with coordinate pairs in a classic OXY plane into a list of colors displayable in the OXY− plane.

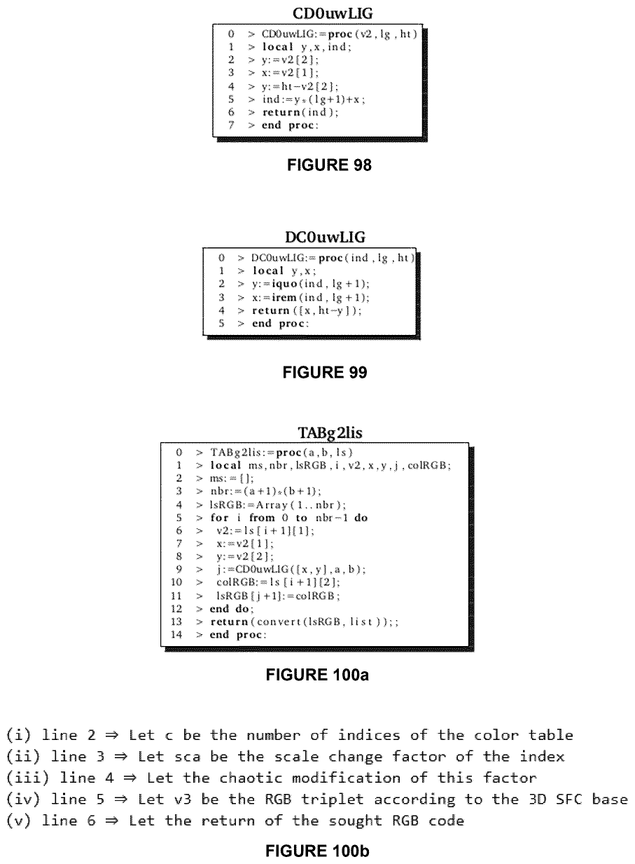

The CDOuwLIG and DCOuwLIG functions in FIGS. 98 and 99 are basic SFCs belonging to specialized coupling tables and libraries that ensure, in particular, the conversion between the colored points positioned in the plane and the sequencing of the RGB codes of these points for their display or printing in an OXY− plane. The decoding function DCOuwLIG (FIG. 99) takes as input the index <ind> of a given point, <lg> and <ht> the widths and heights of the indexing rectangle. The function returns the coordinate pair of the point with the given index. The associated encoding function CDOuwLIG (FIG. 98) takes as input the positive or null coordinates of a point in the OXY plane for the rectangle with widths and heights <lg> and <ht> and returns the index of the point in question in the OXY− plane.

The TABg2lis function in FIG. 100a, commented on in FIG. 100b, performs a reordering of a list of colors displayable in an OXY plane to allow their display in an OXY− plane. The function takes as input <a> and <b>, the resolutions of the display rectangle, and <ls>, the list consisting of a sequence of pairs, each pair being formed by a coordinate pair and the associated color.

The TABg2ppm function in FIG. 101 writes a bitmap file in ASCII PPM format. The function takes as input the number of pixels in width and height <nbrPixL> and <nbrPixH> of the bitmap rectangle, <ls>, the list of RGB color triplets, the directory <path> for the output file location, and its name <nf>. The function returns the generated <nf.ppm> file.

### Basic Colorimetric Operations

The generation of palettes or color tables resulting in lists of distinct RGB codes without repetitions means that the selection of colors is done automatically without any relation between the colors and their possible symbolism. This approach does not specifically address potential issues such as lack of contrast between adjacent colors or the use of reserved color codes to allow for quick visual identification. For example, the colors red and white are used to associate the graphic identifier with Switzerland. A simple post-processing of colors can, for instance, change this coloring by translating the RGB codes and inverting or complementing the color codes by channels (negatives). It is therefore useful to add these color manipulation parameters into the encryption keys and thus be able to modify the RGB codes on the fly. The operation of translating RGB codes can also serve to break the uniqueness of RGB codes due to the effect of code overwriting caused by exceeding the memory encoding limits of the codes, which, once the translation is performed, will be brought back into a range between 0 and 255.

### General Principles

Classical post-processing operations on RGB color codes are converted into on-the-fly operations, with the operation parameters integrated into the encryption keys. Only translation operators, RGB code complementarity, and channel permutation have been integrated for practical purposes. It is also possible to extend RGB encoding to any other standardized color encoding. In this case, higher-dimensional SFCs will replace the three-dimensional SFCs associated with RGB cubes by substituting them with SFCs associated with hypercubes containing the hypercodes of the chosen color model.

### Operations on RGB Codes

Two types of classical color operations allow for the complexity of histogram structures to be increased.

The perRGB function in FIG. 102a, explained in FIG. 102b, takes as input an <RGB> code and <comb>, the indicator for one of the six permutations chosen from the three colors. The function returns the RGB code after permuting its channels.

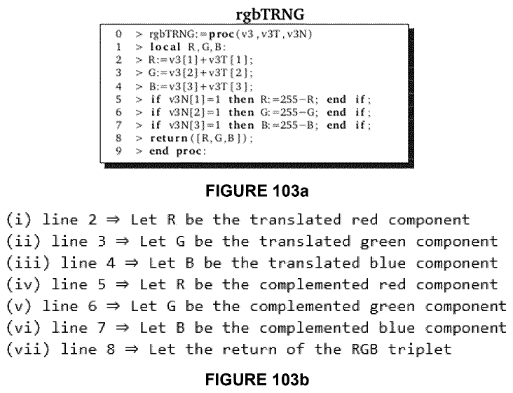

The rgbTRNG function in FIG. 103a, explained in FIG. 103b, performs translation and complement operations on RGB codes. The function expects as input the RGB code <v3>, the translation vector <v37>, and the complement vector <v3N> of the RGB color code. The function returns the transformed RGB color code.

### Extension of Color Models

The proposed encryption system can easily be extended to RGBA encoding or other color models. In this case, four-dimensional SFCs from coupling tables and libraries can be used. Generally, for color models using floating-point numbers, an initial transformation of these numbers into rational numbers (affine space) will be applied, followed by a transition into a projective space to achieve integer-based encoding. Through this method, any floating-point number can be represented by a pair of integers.

It will be appreciated that according to one or more embodiments, one of the methods described above can be used to encode and encrypt information. In the context of encryption, signatures are not initially communicated.

It will be further appreciated by the skilled addressee that one of the methods described above can be used to identify or authenticate an element.

The skilled addressee will appreciate that the element may be of various natures. According to one or more embodiments, the element is an object.

It will be appreciated that at least one or more embodiments of the described methods solve one or more issues and therefore offer numerous advantages.

Regarding the issue of generating an encrypted image, it will be appreciated that a pseudo-random function system is disclosed, allowing the generation of images that are statistically indistinguishable from purely random images. This enables the iterative and adaptive generation of pseudo-random images with random statistical behavior. In one or more implementations, a pseudo-random function system based on Gray meta-curves is also described, enabling lossless image generation in near real-time.

Regarding the issue of complexity, it will be appreciated that an adaptive solution between organized order and pseudo-random disorder is disclosed in one or more embodiments. The issue is also addressed in one or more embodiments by optimizing the Kolmogorov complexity of a file, which is the length of the shortest computer program capable of reproducing the image file. The advantage is that the computer program generating the image serves as the encryption key for the image.

Regarding the issue of the indexing CODEC, it should be noted that this is resolved in one or more embodiments using indexing based on 2D, 3D, nD Gray metacurves. This advantageously allows encoding and decoding through an anonymous function with polynomial complexity. The issue is also resolved in one or more implementations using indexing based on extended 2D, 3D, nD Cantor curves. This advantageously allows simple polynomial complexity encoding and factorial complexity decoding.

Regarding the issue of using permutation libraries, this is resolved in one or more embodiments by using a library of Gray curves and metacurves, which advantageously eliminates the need for generating purely random numbers and enables 2D (pixels), 3D (voxels), and nD (hypervoxels) permutations.

Regarding the issue of numerical precision mentioned above, it is resolved in one or more embodiments through the use of multi-precision integers. This advantageously allows for unconditional geometric and topological programming (no if statements or special cases). This issue is also resolved in one or more embodiments by using a reduced set of operators: +, −, *, irem, iquo, isqrt, \hat{ }, mod 2 (parity test). This advantageously enables bijective encoding and decoding functions without loss. This issue is also resolved in one or more embodiments by avoiding the use of trigonometric functions, which advantageously allows the use of rational mathematical expressions of the circle.

Regarding the issue of memory management, it is resolved in one or more embodiments through the use of dynamic color tables generated on the fly. This advantageously allows sequential or parallel processing of lists of colored pixels. This issue is also resolved in one or more embodiments through the use of procedural Jordan polygons, which advantageously allows sequential or parallel processing (GPU pipeline) of polygon vertices. This issue is also resolved in one or more embodiments through the processing of static images by blocks, which advantageously allows distributed processing of blocks using appropriate SFC scheduling.

Concerning the issue of hardware programming, it is resolved in one or more embodiments through a hybrid parallel architecture with specialized processors (GPU, MPPA, FPGA), which advantageously allows the optimization of computation times oriented towards real-time. This issue is also resolved in one or more embodiments through the use of parallel languages dedicated to processors, which advantageously allows the optimization of parallelism granularity. This issue is also resolved in one or more embodiments through the use of algorithmic programming languages with a parallel ecosystem such as JULIA, which advantageously facilitates the extension of parallel programming libraries for new Gray meta-curve functions.

### REFERENCES

[1] Francisco Gualpuyohualcal. Codex Mendoza. https://codicemendoza.inah.gob.mx/index.php?lang=english, 1541.
[2] Jean Truchet and Sebastien Truchet. Methode pour faire une infinité de desseins differens, avec des carreaux mi-partis de deux couleurs par une ligne diagonale: ou observations du pere dominique douat . . . sur un memoire inseré dans l'histoire de l'academie royale des sciences de paris l'année 1704 présenté par . . . sebastien truchet . . . Chez Florentin de Laulne, 1722.
[3] Kikuo Tanaka. Irohabiki moncho. https://archive.org/details/irohabikimoncho00tana/mode/2up, 1881.
[4] Édouard Lucas. Récréations mathématiques. Gauthier-Villars et fils, 1883.
[5] G. Peano. Sur une courbe, qui remplit toute une aire plane. Mathematische Annalen, 36:157-160, 1890.
[6] David Hilbert. Ueber die stetige abbildung einer linie auf ein flächenstück. Mathematische Annalen, 38:459-460, 1891.
[7] G. Peano. Formulario mathematico. https://books.google.ca/books?id=mcW1MgEACAAJ, 1908.
[8] De Stijl. De stijl nl 1921. https://en.wikiquote.org/wiki/De Stijl, 1921.
[9] Claude E Shannon. A mathematical theory of cryptography. Mathematical Theory of Cryptography, 1945.
[10] W Wunderlich. Über peano-kurven. Elemente der Mathematik, 28:1-10, 1973.
[11] Mark Levoy. Area flooding algorithms. Two-Dimensional Computer Animation, Course Notes 9 for SIGGRAPH, 82, 1981.
[12] Vinzenz Brinkmann. Die aufgemalten namensbeischriften an nord-und ostfries des siphnierschatzhauses. Bulletin de correspondance hellénique, 109(1):77-130, 1985.
[13] Robert Fisch, Janko Gravner, and David Griffeath. Cyclic cellular automata in two dimensions. In Spatial stochastic processes, pages 171-185. Springer, 1991.
[14] Heinz-Otto Peitgen, Hartmut Jürgens, Dietmar Saupe, and Mitchell J Feigenbaum. Chaos and fractals: new frontiers of science. Springer, 1992.
[15] Donald Eastlake, Steve Crocker, and Jeff Schiller. Randomness recommendations for security. Technical report, RFc 1750, December 1994.
[16] Hans Sagan. Space-filling curves. Springer-Verlag, 1994.
[17] Jean-François Rotgé. L'arithmétique des Formes: une introduction à la logique de l'espace. PhD thesis, Université de Montréal, 1997.
[18] Jim Reeds. John dee and the magic tables in the book of soyga. https://archive.org/details/jimreedssoyga, 1998.
[19] Revital Dafner, Daniel Cohen-Or, and Yossi Matias. Context-based space filling curves. In Computer Graphics Forum, volume 19, pages 209-218. Wiley Online Library, 2000.
[20] Anne-Marie Décaillot. Géométrie des tissus. Mosaïques, Echiquiers. Mathématiques curieuses et utiles. Revue d'histoire des mathématiques, 8(2):145-206, 2002.
[21] Jean-Paul Delahaye. La complexité mesurée. Pour la science, 314:34-8, 2003.
[22] Vicky Liu, William Caelli, Ernest Foo, and Selwyn Russell. Visually sealed and digitally signed documents. In Computer Science 2004. Proceedings of the Twenty-Seventh Australasian Computer Science Conference (ACSC2004), pages 287-294. Australian Computer Society, 2004.
[23] Nithin Nagaraj, Vivek Vaidya, and Prabhakar G Vaidya. Re-visiting the one-time pad. arXiv preprint cs/0508079, 2005.
[24] Levi Valgaerts. Space-filling curves an introduction. Technical University Munich, 2005.
[25] Aldo Cortesi. Generating colour maps with space-filling curves. https://corte.si/posts/code/hilbert/swatches, 2010.
[26] Ljiljana Radovic and Slavik Jablan. Vasarely's work—invitation to mathematical and combinatorial visual games. In Proceedings of Bridges 2010: Mathematics, Music, Art, Architecture, Culture, pages 127-134, 2010.
[27] MN Vahia and Nisha Yadav. Harappan geometry and symmetry: A study of geometrical patterns on indus objects. Indian Journal of History of Science, 45(3):343-368, 2010.
[28] S. Kamata. A common key encryption algorithm using n-dimensional hilbert curves. In 2011 7th International Conference on Information Assurance and Security (IAS), pages 275-279, December 2011.
[29] Hamed Sheidaeian, Mohammad Reza Abbasifard, and Behrouz Zolfaghari. Visual Cryptography and Image Steganography Using Space Filling Hilbert Curves. In International Conference on Advanced Computer Theory and Engineering, 4th (ICACTE 2011). ASME Press, 01 2011.
[30] Yue Wu, Joseph P Noonan, Sos Agaian, et al. Npcr and uaci randomness tests for image encryption. Cyber journals: multidisciplinary journals in science and technology, Journal of Selected Areas in Telecommunications (JSAT), 1(2):31-38, 2011.
[31] Ebrahim Zarei Zefreh, Sara Rajaee, and Meysam Farivary. Image security system using recursive cellular automata substitution and its parallelization. In 2011 CSI International Symposium on Computer Science and Software Engineering (CSSE), pages 77-86. IEEE, 2011.
[32] Michael Bader. Space-filling curves: an introduction with applications in scientific computing. Springer Science & Business Media, 2012.
[33] Peter Grassberger. Randomness, information, and complexity. arXiv preprint arXiv: 1208.3459, 2012.
[34] Hüseyin Koçak. Differential and difference equations through computer experiments: with diskettes containing phaser: an animator/simulator for dynamical systems for ibm personal computers. Springer Science & Business Media, 2012.
[35] Jean-François Rotgé. De l'indexation des hypertreillis pyramidaux au codage combinatoire des listes de nombres entiers. hal preprint 00717421, 2012.
[36] V Suresh and CE Veni Madhavan. Image encryption with space-filling curves. Defence Science Journal, 62(1):46, 2012.
[37] M Ephin, Judy Ann Joy, and NA Vasanthi. Survey of chaos based image encryption and decryption techniques. In Amrita International Conference of Women in Computing (AICWIC'13) Proceedings published by International Journal of Computer Applications (IJCA), 2013.
[38] Toufik Mansour. Combinatorics of set partitions. CRC Press Boca Raton, 2013
[39] Musheer Ahmad, Hamed D Alsharari, and Munazza Nizam. Security improvement of an image encryption based on mpixel-chaotic-shuffle and pixel-chaotic-diffusion. arXiv preprint arXiv: 1403.6626, 2014.
[40] Anne-Marie Décaillot. Les Récréations Mathématiques d'Édouard Lucas: quelques éclairages. Historia Mathematica, 41(4):506-517, 2014.
[41] YuanYuan Sun, Lina Chen, Rudan Xu, and Ruiqing Kong. An image encryption algorithm utilizing julia sets and hilbert curves. PloS one, 9: e84655, 01 2014.
[42] Possibly Wrong. allrgb: Hilbert curves and random spanning trees. https://possiblywrong.wordpress.com/2014/04/18/allrgb-hilbert-curves-and-random-spanning-trees/, 2014.
[43] David Griffeath. The cyclic cellular automaton. https://github.com/cormas/Griffeath-model, 2015.
[44] Sohn JiAe. A glimpse at joseon royal seals. https://www.korea.net/NewsFocus/Culture/view?articleid=124596, 2015.
[45] KS Kavya and Mrs Prabavathi. Image encryption using hilbert space filling curve and henon map. Int. J. Innov. Res. Comput. Sci. Technol., 3(3):56-60, 2015.
[46] Jay Eastman. Brief history of barcode scanning. OSA Century of Optics, page 128, 2016.
[47] Li Li, Jinxia Qiu, Jianfeng Lu, and Chin-Chen Chang. An aesthetic qr code solution based on error correction mechanism. Journal of Systems and Software, 116:85-94, 2016.
[48] Assa Naveh and Eran Tromer. Photoproof: Cryptographic image authentication for any set of permissible transformations. In 2016 IEEE Symposium on Security and Privacy (SP), pages 255-271. IEEE, 2016.
[49] Gary Santoro. Victor vasarely's alphabet plastique. https://vertufineart.com/victor-vasarelys-alphabet-plastique/, 2016.
[50] Pauvithraa K. T. Siva Kumar T, Gayathri S. Text message encryption method using hilbert curve based permutation and circular shift operation. IJATES (ISSN: 2348-7550), 04(10):394-401, 2016.
[51] Michael Buchanan. U.S. returns lost treasures of Korea. https://eca.state.gov/ivip/highlight/us-returns-lost-treasures-korea/article-photo-gallery, 06 2017.
[52] Ji Woo Lee, Hyung Gil Hong, Ki Wan Kim, and Kang Ryoung Park. A survey on banknote recognition methods by various sensors. Sensors, 17(2):313, 2017.
[53] Omar Farook Mohammad, Mohd Shafry Mohd Rahim, Subhi Rafeeq Mohammed Zeebaree, and FY Ahmed. A survey and analysis of the image encryption methods. International Journal of Applied Engineering Research, 12(23):13265-13280, 2017.
[54] Fatih Özkaynak. Role of npcr and uaci tests in security problems of chaos based image encryption algorithms and possible solution proposals. In 2017 International conference on computer science and engineering (UBMK), pages 621-624. IEEE, 2017.
[55] Nazim Uddin Sheikh, Tapan Kumar Hazra, Hasina Rahman, Kanyasree Mustafi, and Ajoy Kumar Chakraborty. Multi-variable bijective mapping for secure encryption and decryption. In 2017 8th Annual Industrial Automation and Electromechanical Engineering Conference (IEMECON), pages 338-345. IEEE, 2017.
[56] Bhaskar Mondal. Cryptographic image scrambling techniques, 2018.
[57] Jdd Nkapkop, Yves Effa, and Laurent Bitjoka. Design et implémentation d'un crypto-système d'images basé sur le chaos: Chiffrement d'images par chaos et applications, 08 2018.
[58] Mohit Jain Puneet Kaushik. Study and analysis of image encryption algorithm based on arnold transformation. International Journal of Computer Engineering Technology (IJCET), 9(5):59-63, 2018.
[59] Jean-François Rotgé. Method and system for coding information, February 2018. 9900024-14357468-USPTO.
[60] Gayathri Vijayaraghavan. A survey on security and efficiency issues in chaotic image encryption. 04 2018.
[61] Vishal Devireddy. Allrgb. https://vishald.com/blog/allrgb/, 2019.
[62] A. Flores-Vergara, E. E. García-Guerrero, E. Inzunza-González, O. López-Bonilla, E. Rodríguez-Orozco, J. R. Cárdenas-Valdez, and E. Tlelo-Cuautle. Implementing a chaotic cryptosystem in a 64-bit embedded system by using multiple-precision arithmetic. Nonlinear Dynamics, 96:497-516, 2019.
[63] Rongjun Ge, Guanyu Yang, Jiasong Wu, Yang Chen, Gouenou Coatrieux, and Limin Luo. A novel chaos-based symmetric image encryption using bit-pair level process. IEEE Access, 7:99470-99480, 2019.
[64] Xingbin Liu, Di Xiao, Wei Huang, and Cong Liu. Quantum block image encryption based on arnold transform and sine chaotification model. IEEE Access, 7:57188-57199, 2019.
[65] Manal A. Mizher, Riza Sulaiman, Ayman M. Abdalla, and Manar A. Mizher. An improved simple flexible cryptosystem for 3d objects with texture maps and 2d images. Journal of Information Security and Applications, 47:390-409, 2019.
[66] Yoon-Sung Park and Ji-Su Kim. A study on the typeface of font, the shape royal seal of the ex-emperor sugang in the joseon dynasty. Journal of Digital Convergence, 17(11):493-499, 2019.
[67] Zhenjun Tang, Ye Yang, Shijie Xu, Chunqiang Yu, and Xianquan Zhang. Image encryption with double spiral scans and chaotic maps. Security and Communication Networks, 2019, 2019.
[68] Waldemar Berchtold, Huajian Liu, Martin Steinebach, Dominik Klein, Tobias Senger, and Nicolas Thenee. Jab code-a versatile polychrome 2d barcode. Electronic Imaging, 2020(3):207-1, 2020.
[69] Kathryn Devereaux. Twisted gourd (xicalcoliuhqui): The symbolic language of the pre-columbian rainmakers, a cosmovision of divine rule of a triadic universe. https://thetinkuy.wordpress.com/, 05 2020.
[70] Wen-Wen Hu, Ri-Gui Zhou, Jia Luo, She-Xiang Jiang, and Gao-Feng Luo. Quantum image encryption algorithm based on arnold scrambling and wavelet transforms. Quantum Information Processing, 19(3):1-29, 2020.
[71] Sohn JiAe. Historical seals from Joseon Dynasty returned to Korea. https://www.korea.net/NewsFocus/Culture/view?articleid=182638, 02 2020.
[72] Bhawnesh Kumar, Umesh Kumar Tiwari, Santosh Kumar, Vikas Tomer, and Jasmeet Kalra. Comparison and performance evaluation of boundary fill and flood fill algorithm. Int. J. Innov. Technol. Explor. Eng, 8:9-13, 2020.
[73] Willy Scheibel, Matthias Trapp, Daniel Limberger, and Jürgen Döllner. A taxonomy of treemap visualization techniques. 02 2020.
[74] Jai Ganesh Sekar and C Arun. Comparative performance analysis of chaos based image encryption techniques. Journal of critical reviews, 7(9):1138-1143, 2020.
[75] Zen Juen Lau, Tam Pham, SH Annabel, and Dominique Makowski. Brain entropy, fractal dimensions and predictability: A review of complexity measures for eeg in healthy and neuropsychiatric populations. 2021.
[76] Dirk Rijmenants. Cipher machines and cryptology one-time pad. https://www.ciphermachinesandcryptology.com/en/onetimepad.htm, 2021.
[77] Françoise Bahoken. Le charme d'Herbin. https://neocarto.hypotheses.org/14254, 2022.
[78] Jean-François Rotgé. Fonctions de couplage et chaînage des courbes de Gray surfaciques à centre. https://hal.archives-ouvertes.fr/hal-03745896/file/Article13.pdf, @August 2022. working paper or preprint.
[79] Jean-François Rotgé. Fonctions de couplage et chaînage des courbes de Gray surfaciques à noyaux. https://hal.archives-ouvertes.fr/hal-03745216/file/Article14.pdf, August 2022. working paper or preprint.
[80] Jean-François Rotgé. Fonctions de couplage et chaînage des courbes de Gray surfaciques à réflexions. https://hal.archives-ouvertes.fr/hal-03744206/file/Article15.pdf, August 2022. working paper or preprint.
[81] Jean-François Rotgé. Fonctions de couplage et chaînage des courbes de Gray surfaciques en forme de lacets. https://hal.archives-ouvertes.fr/hal-03737365/file/Article10.pdf, July 2022. working paper or preprint.
[82] Jean-François Rotgé. Fonctions de couplage et chaînage des courbes de Gray surfaciques en forme de méandres. https://hal.archives-ouvertes.fr/hal-03737998/file/Article11.pdf, July 2022. working paper or preprint.
[83] Jean-François Rotgé. Fonctions de couplage et chaînage des courbes de Gray surfaciques en forme de spirales. https://hal.archives-ouvertes.fr/hal-03738025/file/Article12.pdf, July 2022. working paper or preprint.
[84] Jean-François Rotgé. Fonctions de couplage et chaînage des courbes de Gray surfaciques en forme d'escaliers. https://hal.archives-ouvertes.fr/hal-03745141/file/Article16.pdf, August 2022. working paper or preprint.
[85] Jean-François Rotgé. Fonctions de couplage et chaînage des courbes et métacourbes de Gray généralisant les courbes de Hilbert. https://hal.archives-ouvertes.fr/hal-03773928/file/Article9.pdf, September 2022. working paper or preprint.
[86] Jean-François Rotgé. Fonctions de couplage et chaînage des métacourbes de Gray surfaciques à rotors. https://hal.archives-ouvertes.fr/hal-03768804/file/Article2.pdf, September 2022. working paper or preprint.
[87] Jean-François Rotgé. Principes de chaînage des courbes de Gray. https://hal.archives-ouvertes.fr/hal-03759184/file/Article5.pdf, August 2022. working paper or preprint.
[88] Fondation Vasarely. Alvéole 5. https://www.fondationvasarely.org/alveole-5/2022.
[89] Wikipedia. Self-avoiding walk. https://en.wikipedia.org/wiki/Self-avoiding walk, 2022.
[90] Landesmuseum Württemberg. Federschild: Meander und sonne. https://www.leo-bw.de/detail/-Detail/details/DOKUMENT/lmw_museumsobjekte/62/Federschild+%22M%C3%A4ander+und+Sonne%22+aztekisch+um+1520, 2022.
[91] Bhaskar Mondal. Cryptographic Image Scrambling Techniques, pages 37-65. 12 2018.

1. A computer-implemented method for encoding information using a unicellular topological stencil, the method comprising:
obtaining information to encode;
generating a partition in a square, the partition being generated using at least one of a Jordan polygon generator, an SFC generator, and a closed Hamiltonian path generator;
converting the generated partition into a series of triplets representing the partition, wherein each triplet is defined by a point and its two neighbors;
determining a density associated with each point of the square using the series of triplets;
coloring each point of the square using at least the associated density to generate the unicellular topological stencil; and
providing the unicellular topological stencil;
characterized in that the information to be encoded is used in at least one of the generation of the partition in a square, the determination of the density associated with each point of the square, and the coloring of each point of the square.

2. The method as claimed in claim 1, wherein the coloring of each point of the square comprises associating a given color with each determined density.

3. The method as claimed in claim 1, wherein the coloring of each point of the square comprises, for a given point: associating a given color table with each density, and selecting a color from the given color table using a position of the given point in the square.

4. The method as claimed in claim 1, further comprising: obtaining an SFC or a coding MCG traversing the square, and reordering each point of the unicellular topological stencil using the SFC or the coding MCG to provide a scrambled unicellular topological stencil, the reordering modifying the coordinates of each point of the unicellular topological stencil such that for each given point with initial corresponding coordinates in a given scan, new coordinates are assigned to this point, these new coordinates corresponding to an identical index in the SFC or in the coding MCG as an index in the given scan; characterized in that the information to be encoded is used in at least one of the generation of the partition in the square, the determination of the density associated with each point of the square, the coloring of each point of the square, and the obtaining of the SFC or the coding MCG.

5. A computer-implemented method for encoding information using a tiling generated in a square, the method comprising:
obtaining information to encode;
generating an SFC in a square;
generating a tiling in the square using the generated SFC; the tiling being generated by replacing each elementary portion of the SFC with a corresponding tiling; and
providing an indication of the generated tiling;
characterized in that the information to encode is used during the generation of the SFC.

6. The method as claimed in claim 5, wherein the SFC is defined by 8 elementary “S”-shaped portions and wherein the corresponding tiling corresponds to a given identical and fixed tiling for each of the 8 elementary portions.

7. The method as claimed in claim 5, further comprising: obtaining an ASCII string to encode, converting the ASCII string into a sequence of corresponding codes in a given numerical base filling a square array, generating an SFC using a given Gray SFC directrix curve in which each point of the Gray SFC directrix curve is replaced by a pattern corresponding to a given code from the sequence of corresponding codes.

8. A computer-implemented method for encoding information using an image, comprising:
obtaining a first image having a given number of pixels;
obtaining a second image having a given number of pixels identical to the given number of pixels of the first image;
interleaving the first image with the second image to provide an interleaved image, the interleaved image comprising a given number of metapixels identical to the given number of pixels of the first image, each metapixel comprising:
a central portion comprising at least one pixel having an associated value equal to that of a corresponding pixel in one of the first image and the second image,
a peripheral portion surrounding the central portion, the peripheral portion comprising a plurality of pixels each having an associated value equal to that of the pixel corresponding to the other of the first image and the second image; and
providing the interleaved image,
characterized in that the first image is selected from a group of images comprising at least:
a single-cell topological stencil generated using the method as claimed in claim 1.

9. The method as claimed in claim 8, wherein the group of images further comprises a tiling generated by obtaining information to encode;
generating an SFC in a square;
generating a tiling in the square using the generated SFC; the tiling being generated by replacing each elementary portion of the SFC with a corresponding tiling; and
providing an indication of the generated tiling;
characterized in that the information to encode is used during the generation of the SFC.

10. The method as claimed in claim 8, wherein the group of images further comprises a given image.

11. The method as claimed in claim 8, wherein the group of images further comprises a QR code.

12. The method as claimed in claim 8, wherein the group of images further comprises at least one of a static color table and a dynamic color table.

13. The method as claimed in claim 12, wherein the dynamic color table is generated according to a method comprising: generating a two-dimensional SFC traversing the square; and using a hashing function to dynamically associate colors from an RGB color cube to each pixel of the square, wherein the association is controlled by the hashing function using at least one parameter and the generated SFC.

14. The method as claimed in claim 8, wherein the interleaving scheme is selected from a group comprising four typographic modes.

15. The method as claimed in claim 8, further comprising obtaining an SFC or a coding MCG traversing the interleaved image, and reordering each point of the interleaved image using the SFC or the coding MCG to provide a scrambled single-cell topological stencil, the reordering modifying the coordinates of each point of the interleaved image such that for each given point with corresponding initial coordinates in a given scan, new coordinates are assigned to this point, these new coordinates corresponding to an identical index in the SFC or in the coding MCG as an index in the given scan; the reordering allowing for a scrambled interleaved image.

16. The use of the method as claimed in claim 1 to encrypt information.

17. A single-cell topological stencil generated using the method as claimed in claim 1.

18. An image generated using the method as claimed in claim 8.

19-20. (canceled)

21. A computer-implemented method for performing identification or authentication using a dynamic color table in a square, the method comprising:
generating a two-dimensional SFC traversing a square comprising a plurality of pixels;
using a hash function to dynamically associate colors from an RGB color cube to each pixel of the square, wherein the association is controlled by the hash function using at least one parameter and the generated SFC; and
providing the generated color table, the generated color table enabling identification or authentication.

22. The method as claimed in claim 21, further comprising modifying the value of each pixel in the generated color table.
